(19) United States
(12) Patent Application Publication
(10) Pub. No.: US 2020/0288345 A1
(43) Pub. Date: Sep. 10, 2020

(54) SYSTEMS, METHODS, AND APPARATUSES FOR HETEROGENEOUS NETWORK DATA COMMUNICATION AND SYNCHRONIZATION

(71) Applicant: Alibaba Group Holding Limited, Grand Cayman (KY)

(72) Inventor: Peisi CHU, Beijing (CN)

(21) Appl. No.: 16/798,970

(22) Filed: Feb. 24, 2020

(30) Foreign Application Priority Data
Mar. 7, 2019 (CN) 201910172299.1

(51) Int. Cl. H04W 28/02; H04W 72/08; H04W 72/04

(52) U.S. Cl. CPC H04W 28/0278; H04W 88/16; H04W 72/0486; H04W 72/08

(57) ABSTRACT

Embodiments of the disclosure provide a method for data communication, a method for data synchronization, and a system, an apparatus, and a device for data communication. In one embodiment, a first gateway caches first communication data sent by a first terminal in a shared transmit queue. At least one network channel is selected from a plurality of network channels established based on different network protocols. The first communication data in the shared transmit queue is sent to a second gateway through the at least one network channel, so that the second gateway sends the first communication data to a second terminal. The embodiments of the disclosure can improve the quality of communication between devices.

### CROSS-REFERENCE TO RELATED APPLICATIONS

This application claims the benefit of priority to Chinese Application No. 201910172299.1, filed on Mar. 7, 2019, which is hereby incorporated by reference in its entirety.

### BACKGROUND

### Technical Field

Embodiments of the disclosure relate to the field of network technologies, and in particular, to a method for data communication, a method, a system, and an apparatus for data synchronization, a gateway device, a server, and a base station device.

### Description of the Related Art

In the field of Internet of Things (IoT), devices frequently communicate with each other. For example, data generated by a device A needs to be sent to other devices such as a device B and a device C through a network to accomplish data synchronization between a plurality of devices. Moreover, certain requirements exist for the synchronization rate and synchronization delay of data between the devices.

In some places such as large and medium-scale activity sites, devices need to carry out long-distance communication with each other due to the large space. To simplify the network setup and network configuration between the devices, an IoT gateway is used to achieve the long-distance communication between the devices. Current IoT gateways mainly rely on existing mobile communication networks. However, gathering of large crowds makes the mobile communication network overburdened in dense areas, and causes network paralysis and greatly lowered quality of communication between devices. As a result, service requirements cannot be met using existing technology.

### SUMMARY

Embodiments of the disclosure provide a method for data communication, a method, a system, and an apparatus for data synchronization, a gateway device, a server, and a base station device, which further improve the quality of communication between devices.

In one embodiment, the disclosure provides a method for data communication, the method comprising: caching, by a first gateway, first communication data sent by a first terminal in a shared transmit queue; selecting at least one network channel from a plurality of network channels established based on different network protocols; and sending the first communication data in the shared transmit queue to a second gateway through the at least one network channel, so that the second gateway sends the first communication data to a second terminal, wherein the first gateway, the first terminal, the second gateway, and the second terminal are deployed in the same site area.

In one embodiment, the disclosure provides a method for data communication, the method comprising: receiving first communication data sent by a first gateway through at least one network channel, wherein the at least one network channel is selected and obtained by the first gateway from a plurality of network channels established based on different network protocols, and the first communication data is sent by a first terminal to a shared transmit queue of the first gateway for caching; determining a second gateway associated with the first gateway; and forwarding the first communication data to the second gateway through the at least one network channel, so that the second gateway sends the first communication data to a second terminal, wherein the first gateway, the first terminal, the second gateway, and the second terminal are deployed in the same site area.

In one embodiment, the disclosure provides a method for data communication, the method comprising: receiving first communication data sent by a first gateway through a self-organizing network channel, wherein the self-organizing network channel is selected and obtained by the first gateway from a plurality of network channels established based on different network protocols, and the first communication data is sent by a first terminal to a shared transmit queue of the first gateway for caching; determining a second gateway associated with the first gateway; and forwarding the first communication data to the second gateway through the self-organizing network channel, so that the second gateway sends the first communication data to a second terminal, wherein the first gateway, the first terminal, the second gateway, and the second terminal are deployed in the same site area.

In one embodiment, the disclosure provides a method for data communication, the method comprising: receiving first communication data sent by a first gateway through the at least one network channel, wherein the at least one network channel is selected and obtained by the first gateway from a plurality of network channels established based on different network protocols, and the first communication data is sent by a first terminal to a shared transmit queue of the first gateway for caching; determining a second terminal associated with the first terminal; and sending the first communication data to the second terminal, wherein the first gateway, the first terminal, the second gateway, and the second terminal are deployed in the same site area.

In one embodiment, the disclosure provides a method for data synchronization, the method comprising: caching, by a first gateway, first synchronization data sent by a first IoT terminal in a shared transmit queue; selecting at least one network channel from a plurality of network channels established based on different network protocols; and sending the first synchronization data in the shared transmit queue to a second gateway through the at least one network channel, so that the second gateway sends the first synchronization data to a second IoT terminal and the second IoT terminal performs data synchronization according to the first synchronization data, wherein the first gateway, the first IoT terminal, the second gateway, and the second IoT terminal are deployed in the same site area.

In one embodiment, the disclosure provides a method for data synchronization, the method comprising: receiving first synchronization data sent by a first gateway through at least one network channel, wherein the at least one network channel is selected and obtained by the first gateway from a plurality of network channels established based on different network protocols, and the first synchronization data is sent by a first IoT terminal to a shared transmit queue of the first gateway for caching; determining a second gateway associated with the first gateway; and forwarding the first synchronization data to the second gateway through the at least one network channel, so that the second gateway sends the first synchronization data to a second IoT terminal and the second IoT terminal performs data synchronization based on the first synchronization data, wherein the first gateway, the first IoT terminal, the second gateway, and the second IoT terminal are deployed in the same site area.

In one embodiment, the disclosure provides a method for data synchronization, the method comprising: receiving first synchronization data sent by a first gateway through a self-organizing network channel, wherein the self-organizing network channel is selected and obtained by the first gateway from a plurality of network channels established based on different network protocols, and the first synchronization data is sent by a first IoT terminal to a shared transmit queue of the first gateway for caching; determining a second gateway associated with the first gateway; and forwarding the first synchronization data to the second gateway through the self-organizing network channel, so that the second gateway sends the first communication data to a second IoT terminal and the second IoT terminal performs data synchronization based on the first synchronization data, wherein the first gateway, the first IoT terminal, the second gateway, and the second IoT terminal are deployed in the same site area.

In one embodiment, the disclosure provides a method for data synchronization, the method comprising: receiving first synchronization data sent by a first gateway through the at least one network channel, wherein the at least one network channel is selected and obtained by the first gateway from a plurality of network channels established based on different network protocols, and the first synchronization data is sent by a first IoT terminal to a shared transmit queue of the first gateway for caching; determining a second IoT terminal associated with the first IoT terminal; and sending the first synchronization data to the second IoT terminal, so that the second IoT terminal performs data synchronization based on the first synchronization data, wherein the first gateway, the first IoT terminal, the second gateway, and the second IoT terminal are deployed in the same site area.

In one embodiment, the disclosure provides a system for data communication, the system comprising: a plurality of gateways deployed in the same site area and at least one terminal connected to each gateway, wherein any two gateways establish a plurality of network channels therebetween based on different network protocols; a first gateway is configured to cache first communication data sent by a first terminal in a shared transmit queue; select at least one network channel from a plurality of network channels established based on different network protocols; and send the first communication data in the shared transmit queue to a second gateway through the at least one network channel; and the second gateway is configured to receive, through the at least one network channel, the first communication data sent by the first gateway, and send the first communication data to a second terminal.

In one embodiment, the disclosure provides an apparatus for data communication, the apparatus comprising: a first receiving module, configured to cache, by a first gateway, first communication data sent by a first terminal in a shared transmit queue; a first network selection module, configured to select at least one network channel from a plurality of network channels established based on different network protocols; and a first sending module, configured to send the first communication data in the shared transmit queue to a second gateway through the at least one network channel, so that the second gateway sends the first communication data to a second terminal, wherein the first gateway, the first terminal, the second gateway, and the second terminal are deployed in the same site area.

In one embodiment, the disclosure provides an apparatus for data communication, the apparatus comprising: a second receiving module, configured to receive first communication data sent by a first gateway through at least one network channel, wherein the at least one network channel is selected and obtained by the first gateway from a plurality of network channels established based on different network protocols, and the first communication data is sent by a first terminal to a shared transmit queue of the first gateway for caching; a first determining module, configured to determine a second gateway associated with the first gateway; and a second sending module, configured to forward the first communication data to the second gateway through the at least one network channel, so that the second gateway sends the first communication data to a second terminal, wherein the first gateway, the first terminal, the second gateway, and the second terminal are deployed in the same site area.

In one embodiment, the disclosure provides an apparatus for data communication, the apparatus comprising: a third receiving module, configured to receive first communication data sent by a first gateway through a corresponding self-organizing network channel, wherein the self-organizing network channel is selected and obtained by the first gateway from a plurality of network channels established based on different network protocols, and the first communication data is sent by a first terminal to a shared transmit queue of the first gateway for caching; a second determining module, configured to determine a second gateway associated with the first gateway; and a third sending module, configured to forward the first communication data to the second gateway through the self-organizing network channel, so that the second gateway sends the first communication data to a second terminal, wherein the first gateway, the first terminal, the second gateway, and the second terminal are deployed in the same site area.

In one embodiment, the disclosure provides an apparatus for data communication, the apparatus comprising: a fourth receiving module, configured to receive first communication data sent by a first gateway through the at least one network channel, wherein the at least one network channel is selected and obtained by the first gateway from a plurality of network channels established based on different network protocols, and the first communication data is sent by a first terminal to a shared transmit queue of the first gateway for caching; a third determining module, configured to determine a second terminal associated with the first terminal; and a fourth sending module, configured to send the first communication data to the second terminal, wherein the first gateway, the first terminal, the second gateway, and the second terminal are deployed in the same site area.

In one embodiment, the disclosure provides an apparatus for data synchronization, the apparatus comprising: a first receiving module, configured to cache, by a first gateway, first synchronization data sent by a first IoT terminal in a shared transmit queue; a first network selection module, configured to select at least one network channel from a plurality of network channels established based on different network protocols; and a first sending module, configured to send the first synchronization data in the shared transmit queue to a second gateway through the at least one network channel, so that the second gateway sends the first synchronization data to a second IoT terminal and the second IoT terminal performs data synchronization according to the first synchronization data, wherein the first gateway, the first IoT terminal, the second gateway, and the second IoT terminal are deployed in the same site area.

In one embodiment, the disclosure provides an apparatus for data synchronization, the apparatus comprising: a second receiving module, configured to receive, by a first synchronization data receiving module, first synchronization data sent by a first gateway through at least one network channel, wherein the at least one network channel is selected and obtained by the first gateway from a plurality of network channels established based on different network protocols, and the first synchronization data is sent by a first IoT terminal to a shared transmit queue of the first gateway for caching; a first determining module, configured to determine a second gateway associated with the first gateway; and a second sending module, configured to forward the first synchronization data to the second gateway through the at least one network channel, so that the second gateway sends the first synchronization data to a second IoT terminal and the second IoT terminal performs data synchronization based on the first synchronization data, wherein the first gateway, the first IoT terminal, the second gateway, and the second IoT terminal are deployed in the same site area.

In one embodiment, the disclosure provides an apparatus for data synchronization, the apparatus comprising: a third receiving module, configured to receive first synchronization data sent by a first gateway through a self-organizing network channel, wherein the self-organizing network channel is selected and obtained by the first gateway from a plurality of network channels established based on different network protocols, and the first synchronization data is sent by a first IoT terminal to a shared transmit queue of the first gateway for caching; a second determining module, configured to determine a second gateway associated with the first gateway; and a third sending module, configured to forward the first synchronization data to the second gateway through the self-organizing network channel, so that the second gateway sends the first communication data to a second IoT terminal and the second IoT terminal performs data synchronization based on the first synchronization data, wherein the first gateway, the first IoT terminal, the second gateway, and the second IoT terminal are deployed in the same site area.

In one embodiment, the disclosure provides an apparatus for data synchronization, the apparatus comprising: a fourth receiving module, configured to receive first synchronization data sent by a first gateway through the at least one network channel, wherein the at least one network channel is selected and obtained by the first gateway from a plurality of network channels established based on different network protocols, and the first synchronization data is sent by a first IoT terminal to a shared transmit queue of the first gateway for caching; a third determining module, configured to determine a second IoT terminal associated with the first IoT terminal; and a fourth sending module, configured to send the first synchronization data to the second IoT terminal, so that the second IoT terminal performs data synchronization based on the first synchronization data, wherein the first gateway, the first IoT terminal, the second gateway, and the second IoT terminal are deployed in the same site area.

In one embodiment, the disclosure provides a gateway device, comprising a processing component and a storage component, wherein the storage component is configured to store one or a plurality of computer instructions, wherein the one or plurality of computer instructions are invoked and executed by the processing component; and the processing component is configured to: cache, by a first gateway, first communication data sent by a first terminal in a shared transmit queue; select at least one network channel from a plurality of network channels established based on different network protocols; and send the first communication data in the shared transmit queue to a second gateway through the at least one network channel, so that the second gateway sends the first communication data to a second terminal, wherein the first gateway, the first terminal, the second gateway, and the second terminal are deployed in the same site area.

In one embodiment, the disclosure provides a server, comprising a processing component and a storage component, wherein the storage component is configured to store one or a plurality of computer instructions, wherein the one or plurality of computer instructions are invoked and executed by the processing component; and the processing component is configured to: receive first communication data sent by a first gateway through at least one network channel, wherein the at least one network channel is selected and obtained by the first gateway from a plurality of network channels established based on different network protocols, and the first communication data is sent by a first terminal to a shared transmit queue of the first gateway for caching; determine a second gateway associated with the first gateway; and forward the first communication data to the second gateway through the at least one network channel, so that the second gateway sends the first communication data to a second terminal, wherein the first gateway, the first terminal, the second gateway, and the second terminal are deployed in the same site area.

In one embodiment, the disclosure provides a base station device, comprising a processing component and a storage component, wherein the storage component is configured to store one or a plurality of computer instructions, wherein the one or plurality of computer instructions are invoked and executed by the processing component; and the processing component is configured to: receive first communication data sent by a first gateway through a corresponding self-organizing network channel, wherein the self-organizing network channel is selected and obtained by the first gateway from a plurality of network channels established based on different network protocols, and the first communication data is sent by a first terminal to a shared transmit queue of the first gateway for caching; determine a second gateway associated with the first gateway; and forward the first communication data to the second gateway through the self-organizing network channel, so that the second gateway sends the first communication data to a second terminal, wherein the first gateway, the first terminal, the second gateway, and the second terminal are deployed in the same site area.

In one embodiment, the disclosure provides a gateway device, comprising a processing component and a storage component, wherein the storage component is configured to store one or a plurality of computer instructions, wherein the one or plurality of computer instructions are invoked and executed by the processing component; and the processing component is configured to: receive first communication data sent by a first gateway through the at least one network channel, wherein the at least one network channel is selected and obtained by the first gateway from a plurality of network channels established based on different network protocols, and the first communication data is sent by a first terminal to a shared transmit queue of the first gateway for caching; determine a second terminal associated with the first terminal; and send the first communication data to the second terminal, wherein the first gateway, the first terminal, the second gateway, and the second terminal are deployed in the same site area.

Compared with current systems, the disclosure can achieve the following technical effects: Embodiments of the disclosure provide a method for data communication, a method, a system, and an apparatus for data synchronization, a gateway device, a server, and a base station device. In the method for data communication provided in the disclosure, a first gateway supporting transmission using different network protocols establishes a plurality of network channels with a second gateway based on different network protocols. The first gateway caches first communication data sent by a first terminal in a shared transmit queue corresponding to the plurality of network channels, so that at least one network channel is selected from the plurality of network channels to jointly transmit the first communication data to the second gateway through the shared transmit queue. Compared with the conventional approach of performing data communication using only one network channel, the reliability of communication and rate of data synchronization between the first gateway and the second gateway in a site area can be greatly improved, and the communication delay can be effectively reduced, thereby improving communication quality.

These or other aspects of the disclosure will become clearer and more comprehensible in the following description of embodiments.

### BRIEF DESCRIPTION OF THE DRAWINGS

To describe the technical solutions in the embodiments of the disclosure, accompanying drawings to be used for description of the embodiments are briefly introduced below. The accompanying drawings in the following description are merely some of the embodiments of the disclosure. Those of ordinary skill in the art can further obtain other accompanying drawings according to these accompanying drawings without significant efforts.

FIG. 1 is a flow diagram illustrating a method for data communication provided according to some embodiments of the disclosure.

FIG. 2 is a diagram of a plurality of network channels of one type established between a first gateway and a second gateway based on different network protocols provided according to some embodiments of the disclosure.

FIG. 3 is a diagram of a plurality of network channels of another type established between a first gateway and a second gateway based on different network protocols provided according to some embodiments of the disclosure.

FIG. 4 is a diagram illustrating adjustment of data packet proportions of at least one network channel provided according to some embodiments of the disclosure.

FIG. 5 is a flow diagram illustrating a method for data communication provided according to some embodiments of the disclosure.

FIG. 6 is a flow diagram illustrating a method for data communication provided according to some embodiments of the disclosure.

FIG. 7 is a flow diagram illustrating a method for data communication provided according to some embodiments of the disclosure.

FIG. 8 is a block diagram illustrating a system for data communication provided according to some embodiments of the disclosure.

FIG. 9 is a block diagram illustrating a system for data communication provided according to some embodiments of the disclosure.

FIG. 10 is a block diagram illustrating an apparatus for data communication provided according to some embodiments of the disclosure.

FIG. 11 is a block diagram illustrating an apparatus for data communication provided according to some embodiments of the disclosure.

FIG. 12 is a block diagram illustrating an apparatus for data communication provided according to some embodiments of the disclosure.

FIG. 13 is a block diagram illustrating an apparatus for data communication provided according to some embodiments of the disclosure.

FIG. 14 is a block diagram illustrating a gateway device provided according to some embodiments of the disclosure.

FIG. 15 is a block diagram illustrating a server provided according to some embodiments of the disclosure.

FIG. 16 is a block diagram illustrating a base station device provided according to some embodiments of the disclosure.

FIG. 17 is a block diagram illustrating a gateway device provided according to some embodiments of the disclosure.

### DETAILED DESCRIPTION

To enable those skilled in the art to better understand the solutions of the disclosure, the technical solutions in the embodiments of the disclosure will be clearly and completely described below with reference to the accompanying drawings in the embodiments of the disclosure.

Some processes described herein or depicted in the drawings include a plurality of operations occurring in a specific sequence. However, these operations may not be performed in the specific sequence depicited or may be performed in parallel. Sequence numbers of the operations such as 101 or 102 are used only to distinguish between different operations, and the sequence numbers per se do not imply any execution sequence. Additionally, these processes may include more or fewer operations, and these operations may be performed in sequence or in parallel. It should be noted that the descriptions such as “first” and “second” herein are used to distinguish between different messages, devices, modules, and the like; they do not imply the precedence order or limit that the “first” and “second” are of different types.

As described previously, current IoT gateways rely on existing mobile communication networks. However, in some sites or places with large people flow density, gathering of large crowds makes the mobile communication network overburdened and causes network paralysis and greatly lowered quality of communication between devices, for example, an increased communication delay or a low data synchronization rate. As a result, actual service requirements cannot be met for services having certain requirements for the synchronization rate and delay of data communication between devices.

In embodiments of the disclosure, a first gateway supporting transmission using different network protocols establishes a plurality of network channels with a second gateway based on different network protocols. The first gateway caches first communication data sent by a first terminal in a shared transmit queue corresponding to the plurality of network channels, so that at least one network channel is selected from the plurality of network channels to jointly transmit the first communication data to the second gateway through the shared transmit queue. Compared with the conventional approach of performing data communication using only one network channel, the reliability of communication and rate of data synchronization between the first gateway and the second gateway in a site area can be greatly improved, and the communication delay can be effectively reduced, thereby improving communication quality.

The technical solutions in the embodiments of the disclosure will be described below with reference to the accompanying drawings in the embodiments of the disclosure. The described embodiments are merely some, rather than all of the embodiments of the disclosure. All other embodiments obtained by those skilled in the art on the basis of the embodiments in the disclosure without significant efforts fall within the scope of the disclosure.

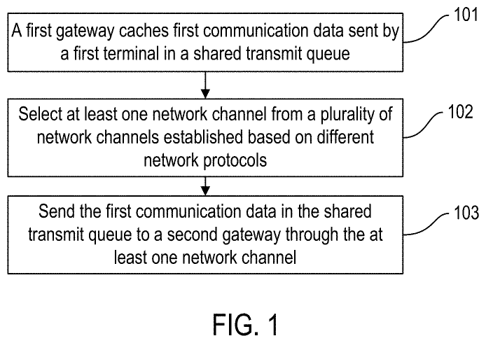

FIG. 1 is a flow diagram illustrating a method for data communication provided in some embodiments of the disclosure. The method may be implemented by a first gateway device and may include the following steps.

Step 101: a first gateway caches first communication data sent by a first terminal in a shared transmit queue.

The gateway device is used for implementing network interconnection over a network layer and is an intermediate device for linking up two networks having different upper-layer protocols. In the IoT application scenario, the gateway may further be used as an IoT gateway to implement both wide area network interconnection and local area network (LAN) interconnection.

The gateway device may establish a network connection to a terminal in a certain area to form a LAN, and the gateway device may be used to implement data communication between devices in the LAN. Meanwhile, the gateway device may further establish a connection to a server to implement data communication between a terminal device and the server. A network connection is built between the terminal device and the gateway device based on Wi-Fi (Wireless Fidelity) connection, Bluetooth, wired, or other wireless connection modes to implement data communication between terminal devices in the LAN, and the gateway may be used to implement control over a device interconnected thereto.

However, for large and medium-scale places, for example, large-scale concert sites, exhibition sites, tourist areas, airports, stations, pastures, farms, or factories, terminal devices are scattered at different locations due to the size of the space. Not all terminals can be connected to the same gateway device because of the limited connection capability of each gateway, for example, limitation of the power of wireless signals or limitation of the number of connected terminals. Therefore, to facilitate building of an IoT network, terminal devices in different areas of the place are respectively connected to different gateway devices to obtain a plurality of LANs, and interconnection between the plurality of gateway devices is established to implement data communication between two terminal devices in different LANs.

Each gateway device is provided with a plurality of network modules that can be connected to different networks, so that the gateway device has the capability of connecting to different networks. The gateway device connecting to a plurality of networks builds a network connection to any gateway based on a network protocol corresponding to each network to form a plurality of network channels.

Step 102: select at least one network channel from a plurality of network channels established based on different network protocols.

Step 103: send the first communication data in the shared transmit queue to a second gateway through the at least one network channel, so that the second gateway sends the first communication data to a second terminal.

In one embodiment, the first gateway, the first terminal, the second gateway, and the second terminal are deployed in the same site area.

The site area may include a large and medium-scale area such as a performance site, a conference site, an activity site, or an exhibition site. Certainly, the method is not limited to a site area, and is also applicable to other large and medium-scale or small-scale places inconvenient for cable deployment, which is not specifically limited herein.

The caching, by a first gateway, first communication data sent by a first terminal in a shared transmit queue may further include: (1) receiving, by the first gateway, the first communication data sent by the first terminal; and (2) caching the first communication data in the shared transmit queue.

After the first gateway receives the communication data sent by the first terminal, a network interface of each network channel in the first gateway may share a protocol stack queue. The protocol stack queue may include a shared transmit queue, a shared receive queue, and a shared retransmission queue. The shared protocol stack queue gathers all network protocols of each network module, protocol conversion between different network protocols can be implemented through the shared protocol stack queue to share communication data of different network protocols in the shared protocol queue, and the at least one network channel can jointly transmit the first communication data through the shared protocol stack queue.

The first terminal can perform data communication not only with a terminal device in a different LAN but also with a terminal device in the same LAN. Optionally, in some embodiments, before the selecting at least one network channel from a plurality of network channels established based on different network protocols, the method may further include: determining whether the second terminal is interconnected to the first gateway; if so, then sending the first communication data to the second terminal; and if not, then selecting at least one network channel from the plurality of network channels established based on different network protocols.

If the second terminal is interconnected to the first gateway, then it is indicated that the second terminal and the first terminal are in the same LAN. Therefore, only a first network is needed for sending the first communication data to the second terminal. The first gateway further has a communication protocol conversion function to achieve cooperation between different network channels. A first terminal device and a second terminal device may be connected to the first gateway based on the same network protocol or may be connected to the gateway based on different network protocols. For example, the first terminal is connected to the first gateway by means of Bluetooth, and the second terminal is connected to the first network through a LoRa (Long Range, ultra-long range low-power consumption data transmission network) network. In this case, the first gateway first needs to perform protocol conversion on a communication protocol of the first communication data, that is, convert a Bluetooth communication protocol into a LoRa network communication protocol to ensure that the first communication data is sent to the second terminal through a LoRa network module of the first gateway.

If the first terminal and the second terminal are in different LANs, then the first gateway needs to send the first communication data in the shared transmit queue to the second gateway through the at least one selected network channel, so that the second gateway sends the first communication data to the second terminal. It can be understood that the first communication data sent by the first terminal also needs to be subjected to protocol conversion to obtain a communication protocol corresponding to the at least one network channel. For example, after the first terminal sends the first communication data to the first gateway based on a Bluetooth protocol, the at least one network channel selected by the first gateway is respectively a Narrowband Internet of Things (NB-IoT) network channel and a LoRa network channel, and then, the communication protocol of the first communication data is converted into an NB-IoT protocol and a LoRa protocol respectively.

In this embodiment, the phenomenon that use of only one network channel for data communication affects data communication between devices and thus affects actual service processing due to paralysis or congestion of the network channel can be avoided. At least one network channel is selected to jointly perform data communication between devices, to achieve higher communication efficiency and communication quality. In addition, the combination of different network channels can meet communication requirements in a variety of service scenarios and can desirably counteract the impact of an external environment on device communication, thereby achieving stable and reliable data transmission of communication between devices.

The gateway device may be connected to a non-self-organizing network, for example, an Ethernet/mobile communication network, an SMS (short message service) network, or an NB-IoT network, built by a network operator through a built-in network module, or may be connected to a self-organizing network, for example, a LoRa network or an ad hoc (point-to-point) network, which is not limited herein.

In one embodiment, the first gateway, no matter whether connected to a non-self-organizing network or connected to a self-organizing network, can establish at least one network connection to the server through a self-organizing network protocol or a non-self-organizing network protocol, and the second gateway establishes at least one network connection to the server in the aforementioned manner, to form a plurality of network channels between the first gateway and the second gateway built based on different network protocols. The sending the first communication data in the shared transmit queue to a second gateway through the at least one network channel may include: sending the first communication data in the shared transmit queue to the server through the at least one network channel, so that the server sends the first communication data to the second gateway through the at least one network channel.

For an Ethernet/mobile communication network, the gateway device may be connected to the server through a cable or connected to the server through a mobile communication base station or the like. The network has the advantage of a large bandwidth and a short delay, and the disadvantage that the mobile communication network is susceptible to large flow of people to cause network paralysis and failure of normal communication.

For an NB-IoT network, the gateway device needs to establish a connection to the server through an NB-IoT base station. The NB-IoT network has the characteristics of low power consumption and high connection density. Despite a small network bandwidth, the NB-IoT network is deployed separately from the current mobile communication network and thus can desirably counteract the interference from paralysis of the mobile communication network.

For an SMS network, the gateway device establishes a connection to the server through a SMS center. The SMS network has the characteristic that an upper limit exists for transmission of a single data packet so that the data packet needs to be split and sent in installments, and meanwhile, the SMS network has a long delay but desirable anti-interference performance and thus is not susceptible to an external environment.

For a LoRa network, the gateway device needs to establish a connection to the server through a LoRa base station. The LoRa network has the characteristics of low power consumption and long transmission distance, and thus has a desirable communication capability even if the gateway device is far away. Since the LoRa network is a self-organizing network, the network can be built more flexibly and simply and can be built according to terrain and actual requirements, but the disadvantage is that the LoRa network is susceptible to interference from weather, electromagnetic signals, or the like.

For an ad hoc network, because of the multi-hop performance of the network, for gateway devices close to each other, the gateway devices may be interconnected to establish a connection between any two gateway devices. Certainly, for gateway devices far from each other, at least one gateway device may be connected to the server, and other gateway devices respectively establish network connections to the gateway device connected to the server based on the ad hoc network, which can also form network channels between the first gateway and the second gateway.

The gateway device is connected to a plurality of networks to respectively establish connections to the server based on different network protocols, to establish a plurality of network channels between gateway devices. The server may be a cloud server and can also achieve cloud control over the IoT.

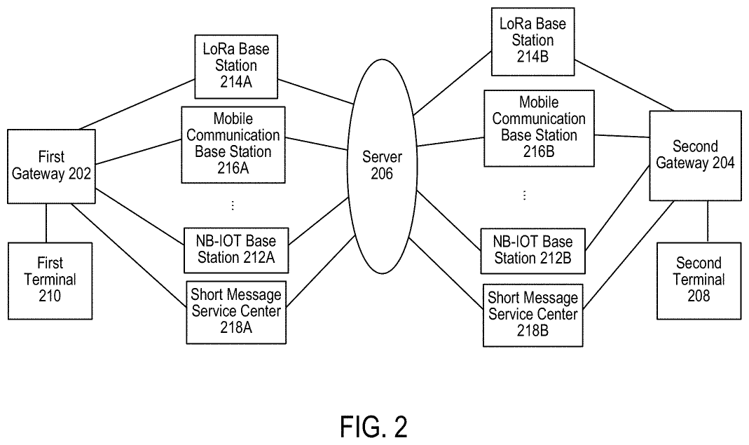

FIG. 2 is a diagram of a plurality of network channels of one type established between the first gateway (202) and the second gateway (204) based on different network protocols. The gateway devices (202, 204) in FIG. 2, no matter whether connected to a self-organizing network or connected to a non-self-organizing network, both establish network connections to the server (206), and a network connection between the second gateway (204) connected to the second terminal (208) and the server (206) can be determined through the server (206), to send first communication data to the second gateway (204).

Optionally, the plurality of network protocols may include a NB-IoT communication protocol; and the sending the first communication data in the shared transmit queue to the server (206) through the at least one network channel, so that the server (206) sends the first communication data to the second gateway (204) through the at least one network channel may include: if the at least one network channel includes an NB-IoT network channel, then sending the first communication data in the shared transmit queue to the server (206) through a first NB-IoT base station (212a), so that the server (206) sends the first communication data to the second gateway (204) through the second NB-IoT base station (212b).

When the first gateway (202) and the second gateway (204) are far from each other, the first gateway (202) and the second gateway (204) need to respectively establish network connections to different NB-IoT base stations (212a, 212b). In this case, the server (206) stores an association relationship between the first terminal (210) and the second terminal (208) to determine the second gateway (204) connected to the second terminal (208) and the second NB-IoT base station (212b) connected to the second gateway (204), to determine a network connection from the server (206) to the second terminal (210) and send the first communication data to the second gateway (204) via the second NB-IoT base station (212b) through the network connection.

In some embodiments, when the first gateway (202) and the second gateway (204) are close to each other, the first gateway (202) and the second gateway (204) may further be connected to the same NB-IoT base station (e.g., 212a or 212b). In this case, the association relationship between the first terminal (210) and the second terminal (208) is stored by the server (206). Thus, the server (206) needs to control the NB-IoT base station (e.g., 212a, 212b) to send the first communication data to the second gateway (204) based on a determined network connection from the server (206) to the second terminal (208).

A self-organizing network base station can have a certain control capability and can store the association relationship between the first terminal (210) and the second terminal (208) to achieve the capability of data forwarding. Therefore, when a self-organizing network does not need to be connected to the server (206) or cannot be connected to the server (206), the gateway device (e.g., 202, 204) only needs to establish a network connection to a self-organizing network base station to establish a corresponding self-organizing network channel.

In one embodiment, the sending the first communication data in the shared transmit queue to a second gateway (204) through the at least one network channel may include: if the at least one network channel is self-organizing network channels established based on different network protocols, then separately sending the first communication data in the shared transmit queue to corresponding self-organizing network base stations based on the at least one self-organizing network channel, so that the self-organizing network base stations respectively send the first communication data to the second gateway (204) through respective corresponding self-organizing network channels.

Self-organizing network base stations can establish network connections to implement mutual communication without connecting to the server (206), and the first communication data does not require service processing by the server (206). In this case, self-organizing network channels between the first gateway (202) and the second gateway (204) may be formed only through interconnection between the self-organizing network base stations.

For example, a LoRa network channel is a self-organizing network channel, and the first gateway (202) establishes a network connection to a LoRa base station (214a) based on a LoRa network protocol and the second gateway (204) establishes a network connection to a LoRa base station (214b) to form a LoRa network channel between the first gateway (202) and the second gateway (204).

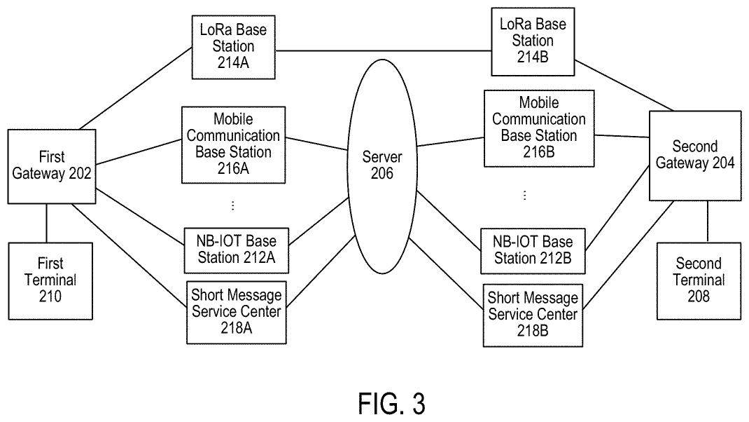

FIG. 3 is a diagram of a plurality of network channels of another type established between the first gateway and the second gateway based on different network protocols.

In the illustrated embodiment, self-organizing network LoRa base stations (214a, 214b) are interconnected, and network connections to gateway devices (202, 204) are respectively established through the LoRa base stations (214a, 214b) to form self-organizing network channels, while for a non-self-organizing network (216a, 216b, 218a, 218b), connections to the server (206) need to be respectively established through gateway devices (202, 204) to implement respective corresponding non-self-organizing network channels. As one embodiment, the sending the first communication data to a second gateway (204) through the at least one network channel may include: if the at least one network channel includes at least one self-organizing network channel established based on different network protocols and at least one non-self-organizing network channel established based on different network protocols, then respectively sending the first communication data in the shared transmit queue to corresponding self-organizing network base stations (e.g., 214a, 214b) through the at least one self-organizing network channel, so that the self-organizing network base stations (e.g., 214a, 214b) respectively forward the first communication data to the second gateway (204) through the at least one self-organizing network channel; and respectively sending the first communication data in the shared transmit queue to the server (206) through the at least one non-self-organizing network channel (e.g., 216a/216b, 218a/218b, 212a/212b), so that the server (206) forwards the first communication data to the second gateway (204) through the at least one non-self-organizing network channel (e.g., 216a/216b, 218a/218b, 212a/212b).

In this embodiment of the disclosure, a plurality of approaches of building different network channels are provided, and an appropriate approach of building network channels may be specifically selected according to actual service requirements and application scenarios to implement data communication between the first gateway (202) and the second gateway (204).

It can be understood that the first gateway (202) and the second gateway (204) in this embodiment of the disclosure are used only to distinguish between a sending end and a receiving end of communication data, but not to limit the first gateway (202) and the second gateway (204) to different types of gateway devices or to limit the number of gateway devices. Therefore, the first gateway (202) and the second gateway (204) may both be at least one gateway device. The same applies to the first terminal (210) and the second terminal (208) in this embodiment of the disclosure.

Based on the above, different networks have different network characteristics. Thus, different networks are affected by the external environment to varying levels, for example, flow of people, weather, interference signals in the environment, or data amount of communication data, and each network channel has varying data transmission performance at different time points. Therefore, the selecting at least one network channel from a plurality of network channels established based on different network protocols may include: monitoring data transmission performance of the plurality of network channels; and selecting at least one network channel from the plurality of network channels according to the data transmission performance of the plurality of network channels and a cached data amount in the shared transmit queue.

The network transmission performance can represent the actual data transmission capability of a network channel, and the most important indicator of the network transmission performance is the packet loss rate of the network. The channel packet loss rate of each channel is monitored in real time to determine the data transmission quality of the network channel. Meanwhile, the data transmission performance of the network channel is determined according to performance indicators such as a bandwidth and a delay of the network channel.

Therefore, at least one network channel combination having high data transmission performance is selected for data transmission according to the amount of data cached in the shared transmit queue and the data transmission performance of each network channel.

For example, a small amount of data is cached, and all network channels have desirable data transmission performance; in this case, a network channel having a large bandwidth and a short delay may be preferentially selected, for example, an Ethernet/mobile communication network channel (e.g., 216a, 216b) is selected for transmitting the first communication data.

If paralysis of the Ethernet/mobile communication network is caused by large number of people, then the network channel will have greatly degraded data transmission performance, and meanwhile the amount of generated first communication data sharply increases, causing a large amount of data cached in the shared transmit queue. A plurality of network channels may be selected to simultaneously send the first communication data. For example, an NB-IoT network channel (212a, 212b), a LoRa network channel (214a, 214b), and an SMS network channel (218a, 218b) are selected to simultaneously send the first communication data to share the transmission load of each network channel, thereby ensuring the shortest delay and highest data possibility in sending the first communication data.

If the Ethernet/mobile communication network (216a, 216b) is congested to a certain level, then an approach of combining an Ethernet/mobile communication network channel (216a, 216b) and a LoRa network channel (214a, 214b) may be selected to send the first communication data.

Optionally, the network channel may further be selected according to service requirements. For example, in the application scenario of data synchronization, if high requirements exist for the delay and synchronization rate of synchronization data, then an Ethernet/mobile communication network channel (216a, 216b) having a large bandwidth and a short delay is preferentially selected to transmit the first communication data, and when the Ethernet/mobile communication network channel (216a, 216b) is congested, network channels having a short delay and a large bandwidth, for example, an NB-IoT network channel (212a, 212b) and a LoRa network channel (214a, 214b), are selected to assist in transmitting the first communication data, thereby ensuring rapid and accurate data synchronization.

However, if the service has low requirements for the delay and synchronization rate of data synchronization, then a self-organizing network may be preferentially selected to perform data transmission of the first communication data, for example, a LoRa network channel (214a, 214b) is preferentially selected, thereby greatly reducing operation costs of a user.

Specifically, at least one network channel may be selected through comprehensive consideration according to a plurality of factors such as actual service requirements of the user, data transmission performance of network channels, and a data amount of communication data, and it is ensured that the data transmission capacity of the at least one network channel must be greater than the data amount of first synchronization data cached in the shared transmit queue.

In this embodiment of the disclosure, the method and policy for selecting network channels according to requirements in different application scenarios and service scenarios is exemplarily described. Certainly, to facilitate automatic selection of network channels, different network selection models may further be set based on service requirements, comprehensive consideration and selection are made in a plurality of dimensions such as the data transmission performance of each network channel, transmission requirements of communication data, and service requirements, and a weight of each dimension is set to obtain an optimal network channel combination, which is not specifically limited herein.

In some embodiments, the caching the first communication data in the shared transmit queue may include: coding the first communication data according to a preset coding protocol to obtain at least one data packet; and caching the at least one data packet in the shared transmit queue.

Each gateway device (202, 204) stores the preset coding protocol and a preset decoding protocol, and the preset coding/decoding protocol may be set according to actual service data, which is not specifically limited herein. Before data sending, the first communication data is encapsulated and coded according to the preset coding protocol to obtain at least one data packet, and the at least one data packet that is obtained by coding is cached in the shared transmit queue.

The sending the first communication data in the shared transmit queue to a second gateway (204) through the at least one network channel may include: determining data packet proportions of the at least one network channel; and sending the data packets in the shared transmit queue to the second gateway (204) through the at least one network channel according to respective data packet proportions.

After at least one network channel is selected and obtained, a data packet proportion of each network channel further needs to be set according to actual requirements. For example, when the network channels have a high packet loss rate, the data packets in the shared transmit queue may all be sent through the at least one network channel, that is, the data packet proportion of each network channel is 100%. However, if the at least one network channel has a low packet loss rate, but high requirements exist for an actual service delay, then the data packets in the shared transmit queue may be proportioned according to the transmission performance of each network channel. The proportion of data packets is increased for a network channel having a short delay and a large bandwidth, and the proportion is decreased for a network channel having a small bandwidth and a long delay. For example, the data packet proportion of an NB-IoT network channel (212a, 212b) is 40%, the data packet proportion of a LoRa network channel (214a, 214b) is 40%, and the data packet proportion of an SMS network channel (218a, 218b) is 20%. That is, the data packets in the shared transmit queue are divided into three parts according to respective proportions and respectively sent to the second gateway through the three network channels. Since each network channel has a certain packet loss rate, a certain redundancy may be set for data packets transmitted on each network channel, and a higher data redundancy may be set for a network channel having a higher packet loss rate, to improve reliability of data transmission.

The data packet proportions and redundancies of the at least one network channel may be set according to the actual situation. The above example is not intended to limit the disclosed embodiments.

The data transmission performance of each network channel and the data amount of the first communication data may change in real time. Thus, the data transmission performance of each network channel may be monitored in real time to adjust the data proportions of the at least one network channel. Therefore, optionally, the method may further include: monitoring data transmission performance of the at least one network channel during sending of the data packets; and adjusting the data packet proportions of the at least one network channel if the data transmission performance changes.

The sending the data packets in the shared transmit queue to the second gateway through the at least one network channel according to respective data packet proportions may include: continuing to send the data packets in the shared transmit queue to the second gateway through the at least one network channel according to respective adjusted data packet proportions.

To ensure that the data packet proportion of each network channel can enable the corresponding network channel to achieve the optimum data transmission capability thereof, a preset threshold may be correspondingly set for the data transmission performance of each network channel, so that when the preset threshold is satisfied, it may be considered that the network channel has a desirable data transmission capability, and when the data transmission performance is lower than the preset threshold, it is indicated that the network has a poor data transmission capability. The preset threshold of each network channel may be set to the same value; or a different preset threshold may be set for each network channel according to different transmission requirements, which may be specifically set according to the actual situation and is not specifically limited herein.

Network parameters of each network may further be adjusted in addition to adjusting the data packet proportions of the network channels. For example, when the LoRa network is subjected to increased external interference, a spreading factor of LoRa may be adjusted to further improve the anti-interference performance of the LoRa network channel. For example, when the mobile communication network channel is congested, QOS (quality of service) of the mobile communication network may be lowered to reduce the data transmission amount of the mobile communication network channel, and if the mobile communication network is in good condition, then the QOS may be raised to ensure stability and reliability of the communication quality. No more examples are given herein for network parameter adjustment of each network channel, which may be specifically set according to actual requirements.

In one embodiment, the adjusting the data packet proportions of the at least one network channel if the data transmission performance changes may include: separately determining whether the data transmission performance of the at least one network channel is greater than a preset threshold; if data transmission performance of any network channel is greater than or equal to the preset threshold, then determining whether a transmitted data amount of the network channel is less than a first transmission threshold; if the transmitted data amount is less than the first transmission threshold, then increasing a data packet proportion of the network channel; if the data transmission performance of the network channel is less than the preset threshold, then determining whether the transmitted data amount of the network channel is greater than a second transmission threshold; and if the transmitted data amount is greater than the second transmission threshold, then decreasing the data packet proportion of the network channel.

The network bandwidth of each network channel is actually fixed, and when the data transmission performance of any network channel reaches the preset threshold, the transmission capability of the network channel may be used as a first transmission threshold. The first transmission threshold is used to represent the current maximum data transmission capacity of any network channel. If the data transmission amount of any network channel is less than the first transmission threshold, then the data packet proportion of the network channel may further be increased until the amount of data transmitted on the network channel reaches the first threshold, to fully utilize the transmission capability of the network channel.

However, if the data transmission performance of any network channel is lower than the preset threshold, then it is considered that the network channel has a poor data transmission capability. Therefore, a lower transmission threshold may be set as a second transmission threshold. The lower transmission threshold may be zero, which indicates that if the data transmission performance is lower than the preset threshold, then the network channel is abandoned so that the data packet proportion thereof is zero. Certainly, according to the actual situation, if each network channel has poor data transmission performance, then a data transmission amount corresponding to a lowest packet loss rate of any network channel may be set as the lower threshold to ensure reliability and stability of the network channel.

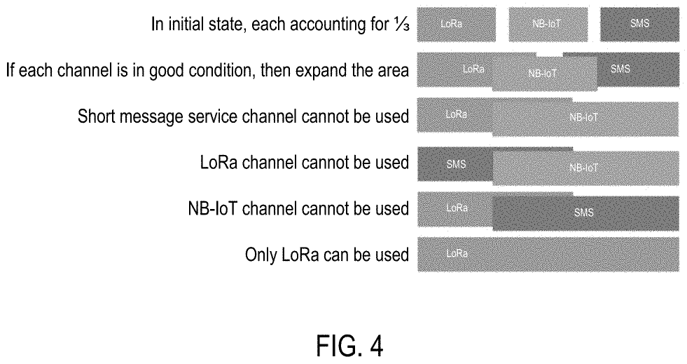

FIG. 4 is a diagram illustrating adjustment of data packet proportions of at least one network channel.

The at least one network channel selected by the first gateway includes a LoRa network channel, an NB-IoT network channel, and an SMS network channel. An initial data packet proportion of each network channel is set to ⅓. That is, if the shared transmit queue has 300 data packets, then each network channel transmits 100 data packets. Meanwhile, the data transmission performance of each network channel is monitored, and the data packet proportion is increased for a network channel having a low packet loss rate, and the data packet proportion is decreased for a network channel having a high packet loss rate until the network channel having the high packet loss rate is abandoned.

The data amount of the first communication data may sharply increase, and thus paralysis of a certain network may occur and the corresponding network channel cannot be used. In this case, the data transmission capacity of the selected network channel cannot meet actual communication requirements; then, at least one network channel may be reselected from a plurality of network channels to make the data transmission capacity of the reselected network channel meet transmission requirements of the first communication data with the sharply increased data amount. Optionally, the method may further include: monitoring data transmission performance of the at least one network channel during sending of the data packets; and if the data transmission performance changes, then determining whether a current data transmission capacity of the at least one network channel is less than a data amount of the data packets in the shared transmit queue; and if so, then reselecting at least one network channel from the plurality of network channels and determining data packet proportions of the at least one reselected network channel.

The sending the data packets in the shared transmit queue to the second gateway through the at least one network channel according to respective data packet proportions includes: sending the data packets in the shared transmit queue to the second gateway through the at least one reselected network channel according to the respective data packet proportions.

If the data amount of the transmitted first communication data sharply decreases, and the network transmission performance changes, then network channels may also be reselected, and the first communication data is transmitted using the minimum number of network channels, to reduce the data processing amount of the second gateway.

For example, when the mobile communication network is in good condition, a combination of a mobile communication network channel and a LoRa network channel may be reselected; when the mobile communication network is paralyzed, a combination of a LoRa network channel and an NB-IoT network channel may be reselected; when the LoRa network is seriously disturbed at the same time, a combination of an NB-IoT network channel and an SMS channel may be re-selected.

Since the network channel has a limited data capacity, unnecessary data transmission may be reduced as much as possible. Therefore, the caching the at least one data packet in the shared transmit queue may include: setting a sequence number for each data packet in an ascending manner according to a coding order of the at least one data packet; and sequentially caching the at least one data packet in the shared transmit queue in an ascending order of the sequence numbers.

A sequence number is set for each data packet to prevent the second gateway from generating a receiving response for each data packet; instead, according to sequence numbers of data packets, a sequence number of an unreceived data packet can be determined to generate a retransmission request and send the same to the first gateway, so that the first gateway retransmits only the data packet not received by the second gateway.

In some embodiments, the sending the data packets in the shared transmit queue to the second gateway through the at least one network channel according to respective data packet proportions may include: determining sequence numbers of data packets respectively corresponding to the at least one network channel according to the respective corresponding data proportions; sequentially acquiring the data packets in the shared transmit queue; and separately sending the data packets in the shared transmit queue to the second gateway through the at least one network channel according to the respective corresponding sequence numbers.

Since the data packets in the shared transmit queue are all provided with sequence numbers, sequence numbers of data packets respectively corresponding to each network channel are determined according to the data packet proportion of each network channel. For example, the shared transmit queue has 300 data packets numbered 1 to 300, and if the data packet proportion of each network channel is 100%, then the sequence numbers of the data packets corresponding to each network channel are all 1 to 300; if the at least one network channel includes an NB-IoT network channel and a LoRa network channel, then data packet proportions thereof respectively correspond to 60% and 40%. It can be determined that the sequence numbers of the data packets corresponding to the NB-IoT network channel may be 1 to 180, and the sequence numbers of the data packets corresponding to the LoRa network channel may be 181 to 300. The foregoing is provided merely as an example. If a certain redundancy is further set, then sequence numbers corresponding to redundant data packets may further be determined according to the redundancy, which may be specifically set according to the actual situation and is not specifically limited herein.

After separately sending the data packets in the shared transmit queue to the second gateway through the at least one network channel according to the respective corresponding sequence numbers, the method may further include: receiving a retransmission request sent by the second gateway, where the retransmission request carries a sequence number of an unreceived data packet; caching a data packet corresponding to the sequence number of the unreceived data packet in a shared retransmission queue; and sending the data packet in the shared retransmission queue to the second gateway through the at least one network channel.

The shared retransmission queue is used for caching a data packet not received by the second gateway and resending the data packet to the second gateway in the aforementioned manner, so the second gateway sequentially caches the received data packets in a shared receive queue in an ascending order of sequence numbers of the data packets, and a decoder connected to the shared receive queue decodes the data packets in the shared receive queue to obtain the first communication data.

In practice, the gateway device can not only implement coding and decoding of the first communication data, but also pre-process the first communication data by means of data compression or data merging to further reduce the data amount of the transmitted first communication data. Besides, the first communication data may further be encrypted and decrypted based on an agreed-upon encryption protocol, to improve the security of the first communication data during transmission to adapt to service scenarios having high requirements for the security coefficient.

In this embodiment of the disclosure, the data transmission performance of each network channel is monitored in real time, so that the data packet proportion of each network channel can be adjusted according to the change of the data transmission performance of each network channel to achieve better communication quality. In addition, at least one network channel may further be reselected according to actual requirements to meet data communication requirements, to ensure that the at least one network channel has the optimum data transmission capability and meets actual service requirements and communication requirements.

In a performance site in the application scenario of data synchronization of an IoT network, a ticket successfully verified on a terminal A should be shown as verified when verified again on a terminal B. This requires the terminal A to synchronize status information indicating ticket verification to the terminal B in time upon successful verification, to avoid the vulnerability of fare evasion caused by verifying one ticket a plurality of times. An IoT terminal device in this service scenario may include a ticket verification terminal, for example, a PDA (Personal Digital Assistant, hand-held terminal), a ticket verification gate, a ticket selling terminal, or a ticket pickup terminal. Network connections to a plurality of terminal devices are established through a gateway device, and a plurality of network channels are established based on different network protocols, to form an IoT application scenario capable of implementing data synchronization.

An embodiment of the disclosure further provides a method for data synchronization, and the method may include: caching, by a first gateway, first synchronization data sent by a first IoT terminal in a shared transmit queue; selecting at least one network channel from a plurality of network channels established based on different network protocols; and sending the first synchronization data in the shared transmit queue to a second gateway through the at least one network channel, so that the second gateway sends the first synchronization data to a second IoT terminal and the second IoT terminal performs data synchronization according to the first synchronization data, where the first gateway, the first IoT terminal, the second gateway, and the second IoT terminal are deployed in the same site area.

In the data synchronization scenario, ticket verification information generated by a ticket verification terminal in the performance site needs to be synchronized to each ticket verification terminal in the same site. As a result, high requirements exist for network performance, requiring that not only a sufficiently short time delay of synchronization needs to be ensured but also a data synchronization rate needs to be ensured, to achieve an extremely low occurrence of errors in the ticket verification result.

Thus, a local gateway and server or self-organizing network base station needs to pre-store an association relationship between various terminal devices, to ensure that the first synchronization data can be sent to each ticket verification terminal accurately in time.

Therefore, the first gateway needs to implement two-stage synchronization. That is, the first-stage synchronization needs to implement data synchronization between associated terminal devices in the same LAN, and the second-stage synchronization needs to implement data synchronization between associated terminals in different LANs.

In this service scenario, the network channels may be selected in the following manner: For some small and medium-scale performance events, when the network is in good condition on site, a mobile communication network having a large bandwidth and a short delay may be preferentially selected as the optimum data synchronization network channel.

However, for large-scale performance events, when crowds gather, the quality of the mobile communication network will be sharply lowered, and intermittent communication occurs. In this case, a LoRa network channel is added as the primary data synchronization transmission channel.

When the mobile communication network is paralyzed, an SMS network channel and an NB-IoT network channel are not affected by the paralysis of the mobile communication network. In this case, the mobile communication network channel may be abandoned, and the LoRa network channel, the SMS network channel, and the NB-IoT network channel jointly transmit the synchronization data.

In this service scenario, the second gateway is all gateway devices associated in the same IoT, and the second terminal is terminal devices connected to the second gateway and associated in the same service scenario.

The technical solution of the disclosure is not limited to synchronization of ticket verification status information, and may further include synchronizing ticket information generated by the ticket selling terminal to the ticket pickup terminal in time to ensure that the user can synchronize ticket information to the ticket pickup terminal in time when an operation such as ticket purchase, ticket refund, or ticket change occurs, to avoid the occurrence of ticket pickup errors in the ticket pickup terminal.

Meanwhile, ticket information of the ticket selling terminal and the ticket pickup terminal also needs to be synchronized to the ticket verification terminal in time to check whether the ticket information is correct or whether ticket checking error information occurs in the scenario in which the ticket is not picked up, or to verify whether a ticket information error occurs, and send alarm information in time when an error occurs, to avoid using a counterfeited ticket, stealing a ticket or verifying a ticket a plurality of times, thereby achieving the purpose of reducing a loss to the user.

The specific implementation of this embodiment of the disclosure has been described in detail above and is not be described herein again.

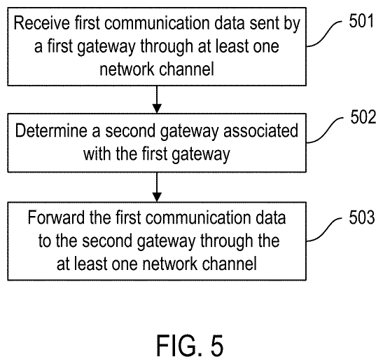

FIG. 5 is a flow diagram illustrating a method for data communication provided in embodiments of the disclosure. The method may be implemented by a server and include the following steps.

Step 501: receive first communication data sent by a first gateway through at least one network channel.

In one embodiment, the at least one network channel is selected and obtained by the first gateway from a plurality of network channels established based on different network protocols, and the first communication data is sent by a first terminal to a shared transmit queue of the first gateway for caching.

Step 502: determine a second gateway associated with the first gateway.

Step 503: forward the first communication data to the second gateway through the at least one network channel, so that the second gateway sends the first communication data to a second terminal.

In one embodiment, the first gateway, the first terminal, the second gateway, and the second terminal are deployed in the same site area.

In one embodiment, the server pre-stores an association relationship between gateway devices and terminal devices, determines the second gateway connected to the second terminal, and sends the first communication data to the second gateway.

According to FIG. 2 and FIG. 3, the first gateway and the second gateway can establish connections to the server through an NB-IoT base station, a SMS center, a mobile communication base station, a LoRa base station or the like based on different network protocols. Therefore, the server further needs to determine whether the first gateway and the second gateway are connected to the same network base station or the same SMS center. If so, then the network base station or SMS center is controlled to send the first communication data to the second gateway; if not, then a network base station or SMS center connected to the second gateway is determined, and the network base station or SMS center is controlled to send the first communication data to the second gateway.

The plurality of network protocols may include a NB-IoT communication protocol. As one embodiment, if the at least one network channel includes an NB-IoT network channel, then the receiving first communication data sent by a first gateway through at least one network channel may include: receiving the first communication data sent by the first gateway through a first NB-IoT base station in the NB-IoT network channel.

An NB-IoT network protocol layer may be optimized so that more devices can be connected to the same NB-IoT base station and more devices are served. The forwarding the first communication data to the second gateway through the at least one network channel, so that the second gateway sends the first communication data to a second terminal may include: forwarding the first communication data to the second gateway through a second NB-IoT base station in the NB-IoT network channel, so that the second gateway sends the first communication data to the second terminal.

Further, the forwarding the first communication data to the second gateway through the second NB-IoT base station, so that the second gateway sends the first communication data to the second terminal may include: grouping second gateways connected to the second NB-IoT base station according to a downlink communication capability of the second NB-IoT base station; and controlling the second NB-IoT base station to sequentially forward the first communication data to each corresponding group of second gateways according to the grouping, so that the second gateways send the first communication data to the second terminal.

The server may pre-acquire the capability of each NB-IoT base station to deliver data. When the number of the second gateways exceeds the data delivery capability of the base station, for example, the NB-IoT base station has only 8 downlink channels, which can achieve the capability of communicating with at most 8 terminal devices each time, but 16 second gateway devices are actually connected, which far exceeds the data delivery capability of the NB-IoT base station, the server may pre-group the second gateways, for example, group the 16 second gateways into two groups, and control the NB-IoT base station to send in two installments the first communication data to the 16 second gateway devices connected to the NB-IoT base station. Thus, the data delivery capability of the base station is prevented from limiting the number of gateways connected to the NB-IoT base station, and the data transmission efficiency of the first communication data can be further improved.

In this embodiment of the disclosure, the server stores an association relationship between devices, and after receiving first communication data, the server determines a second gateway connected to a second terminal and a network base station or SMS center connected to the second gateway based on the pre-stored association relationship between devices, to achieve control over delivery of the first communication data. The control over sending of the communication data by the server can increase the data communication efficiency and enhance the security and reliability of data communication, thereby further improving the quality of communication between devices.

In an application scenario of data synchronization of an IoT network, the disclosure further provides a method for data synchronization, and the method may include: receiving first synchronization data sent by a first gateway through at least one network channel, where the at least one network channel is selected and obtained by the first gateway from a plurality of network channels established based on different network protocols, and the first synchronization data is sent by a first IoT terminal to a shared transmit queue of the first gateway for caching; determining a second gateway associated with the first gateway; and forwarding the first synchronization data to the second gateway through the at least one network channel, so that the second gateway sends the first synchronization data to a second IoT terminal and the second IoT terminal performs data synchronization based on the first synchronization data.

In some embodiments, the first gateway, the first IoT terminal, the second gateway, and the second IoT terminal are deployed in the same site area. The specific implementation of this embodiment of the disclosure has been described in detail above and will not be described herein again.

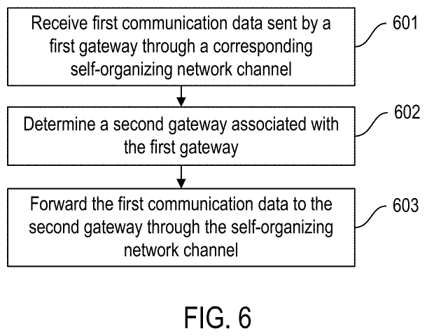

FIG. 6 is a flow diagram illustrating a method for data communication provided in embodiments of the disclosure. The method may be implemented by a base station device and may include the following steps.

Step 601: receive first communication data sent by a first gateway through a self-organizing network channel.

The self-organizing network channel is selected and obtained by the first gateway from a plurality of network channels established based on different network protocols, and the first communication data is sent by a first terminal to a shared transmit queue of the first gateway for caching.

Step 602: determine a second gateway associated with the first gateway.

Step 603: forward the first communication data to the second gateway through the self-organizing network channel, so that the second gateway sends the first communication data to a second terminal.

In one embodiment, the first gateway, the first terminal, the second gateway, and the second terminal are deployed in the same site area.

For base station devices of a self-organizing network, an interconnection between the base stations may be established based on the self-organizing network. In this case, each self-organizing network base station pre-stores an association relationship between devices to achieve control over sending of the first communication data.

For any self-organizing network channel, if the first gateway and the second gateway are connected to different self-organizing network base stations, then after receiving first communication data sent by the first gateway through the self-organizing network channel, a first self-organizing network base station needs to further determine a second self-organizing network base station connected to the second gateway, and send the first communication data to the second self-organizing network base station so that the second self-organizing network base station sends the first communication data to the second gateway.

In this embodiment, the self-organizing network base station pre-stores an association relationship between devices, and determines a second gateway connected to a second terminal and a self-organizing network base station connected to the second gateway based on the association relationship between devices, to achieve control over delivery of first communication data. The control over sending of the first communication data by the self-organizing network base station can not only reduce network use costs of a user, but also increase the data communication efficiency and enhance the security and reliability of data communication, thereby further improving the quality of communication between devices.

In an application scenario of data synchronization of an IoT network, the disclosure further provides a method for data synchronization, and the method may include: receiving first synchronization data sent by a first gateway through a self-organizing network channel, where the self-organizing network channel is selected and obtained by the first gateway from a plurality of network channels established based on different network protocols, and the first synchronization data is sent by a first IoT terminal to a shared transmit queue of the first gateway for caching; determining a second gateway associated with the first gateway; and forwarding the first synchronization data in the shared transmit queue to the second gateway through the self-organizing network channel, so that the second gateway sends the first communication data to a second IoT terminal and the second IoT terminal performs data synchronization based on the first synchronization data.

In one embodiment, the first gateway, the first IoT terminal, the second gateway, and the second IoT terminal are deployed in the same site area.

The specific implementation of this embodiment of the disclosure has been described in detail above and will not be described herein again.

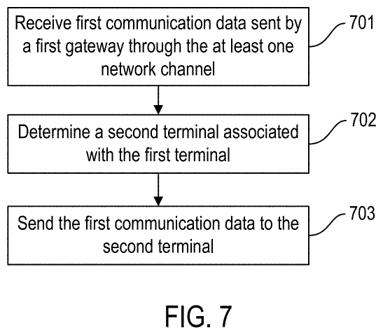

FIG. 7 is a flow diagram illustrating a method for data communication provided in embodiments of the disclosure. The method may be implemented by a gateway device and may include the following steps.

Step 701: receive first communication data sent by a first gateway through the at least one network channel.

The at least one network channel is selected and obtained by the first gateway from a plurality of network channels established based on different network protocols, and the first communication data is sent by a first terminal to a shared transmit queue of the first gateway for caching.

Step 702: determine a second terminal associated with the first terminal.

Step 703: send the first communication data to the second terminal.

In one embodiment, the first gateway, the first terminal, the second gateway, and the second terminal are deployed in the same site area.

After receiving first communication data sent by at least one network channel, the second gateway actually needs to determine a second terminal associated with a first terminal according to a device association relationship pre-stored locally, and send the first communication data to the second terminal so that the second terminal performs service processing according to second communication data.

Besides, it is possible that a device association relationship pre-stored in a local gateway device is not updated in time or a record is erroneous. In this case, the second terminal may not be connected to the second gateway, causing communication interruption. Therefore, after receiving first communication data sent by a first gateway through the at least one network channel, the method may further include: determining whether the second terminal is connected to the second gateway; if not, then generating error prompt information; and outputting, by the second gateway, the error prompt information or sending the error prompt information to the first gateway.

In this case, the first gateway or the second gateway may update a device association relationship list based on the error prompt information, and resend the first communication data to the second terminal according to the updated device association relationship.

In view of the above, the first communication data is coded to obtain at least one data packet and the at least one data packet is cached in a shared transmit queue of the first gateway, and the first gateway sends the at least one data packet in the shared transmit queue to the second gateway through the at least one selected network channel.

Thus, as an optional implementation, the receiving first communication data sent by a first gateway through the at least one network channel may include: separately receiving at least one data packet sent by the at least one network channel selected by the first gateway, where the at least one data packet is obtained by the first gateway by coding the first communication data based on a preset coding protocol; deduplicating the at least one data packet based on a sequence number of each data packet, and sequentially caching data packets obtained after deduplication in a shared receive queue in an ascending order of sequence numbers; and sequentially decoding the data packets in the shared receive queue according to a preset decoding protocol to obtain the first communication data.

Since the at least one network channel jointly transmits data packets, to guarantee the arrival rate of data, a certain data packet redundancy is set, and the same data packet may also be repeatedly sent, for example, in the case in which the network distribution of each network channel is 100%. As a result, the at least one data packet sent by the at least one network channel and received by the second gateway is repeatedly received, so that deduplication of service data is required, and data packets having the same sequence number are deduplicated based on the sequence number of each data packet, to avoid repeatedly sending the first communication data to the second terminal to increase the service amount of the second terminal.

After the at least one received data packet is deduplicated and ordered, the at least one data packet is sequentially cached in the shared receive queue; the at least one data packet in the shared receive queue is decoded by a decoder, and then processing such as decompression and decryption is performed to obtain the first communication data.

In practice, packet loss still occurs in the process of data transmission. After the deduplicating the at least one data packet based on a sequence number of each data packet, and sequentially caching data packets obtained after deduplication in a shared receive queue in an ascending order of sequence numbers, the method may further include: detecting a sequence number of an unreceived data packet; generating a retransmission request based on the sequence number of the unreceived data packet and sending the retransmission request to the first gateway; and receiving a second data packet resent by the first gateway in response to the retransmission request.

A sequence number of an unreceived data packet is detected based on the sequence numbers of the at least one data packet cached in the shared receive queue. For example, it is detected that sequence numbers of received data packets are 1, 3, and 4; then it can be determined that the data packet having a sequence number of 2 is lost and is not received. In this case, a retransmission request for the data packet having the sequence number of 2 may be generated and sent to the first gateway, so that the first gateway resends the corresponding data packet to the second gateway based on the retransmission request. Certainly, it can be understood that a start identifier and an end identifier are set while sequence numbers of the data packets are set, so that the second gateway can determine the total number of the at least one data packet based on the start identifier and the end identifier. However, if the data packet corresponding to the start identifier or the end identifier is lost, then first, resending of the data packet corresponding to the start identifier or the end identifier may be requested, and then it is determined again according to the start identifier and the end identifier whether any data packet is still lost, which is not specifically limited herein.

After obtaining the first communication data, the second gateway further needs to convert the first communication data into a communication protocol for the second terminal to access the network. For example, if the second terminal makes access by means of Bluetooth, then the first communication data needs to be converted into a Bluetooth communication protocol and sent to the second terminal; if the second terminal makes access by means of WIFI or cables, then the first communication data also needs to be converted into a corresponding communication protocol for transmission, which has been described in detail above and will not be described herein again.

Depending on different approaches of building different network channels, the first communication data sent by the at least one network channel and received by the second gateway device may be transmitted based on a network channel formed by a network connection between a server and the second gateway. In one embodiment, the fourth receiving module 1301 may include: receiving the first communication data forwarded by the first gateway through the at least one network channel via a server.

In the case in which a self-organizing network is not connected to the server, the second gateway receiving first communication data sent by a self-organizing network channel may be transmission based on a network channel formed by a network connection between a self-organizing network base station and the second gateway. In one embodiment, the receiving first communication data sent by a first gateway through the at least one network channel may include: receiving the first communication data forwarded by the first gateway through the self-organizing network channel via a self-organizing network base station, where the self-organizing network channel is selected and obtained by the first gateway from the plurality of network channels established based on different network protocols.

In this embodiment of the disclosure, the first gateway and the second gateway are used only to distinguish between a sending end and a receiving end of communication data. The second gateway may also send second communication data to the first gateway according to the aforementioned method to implement interaction of data communication between terminal devices, which is not specifically limited herein.

In this embodiment of the disclosure, the processing of the gateway device after receiving the first communication data is described in detail, and the at least one data packet sent by the first gateway through the at least one network channel is deduplicated and decoded to obtain the first communication data. Unlike current systems in which the second gateway needs to send to the first gateway an acknowledgment frame data packet for each received data packet, in this embodiment of the disclosure, a lost data packet is determined according to sequence numbers of data packets, and only a retransmission request is sent to the first gateway so that the first gateway retransmits the lost data packet, which can not only effectively reduce unnecessary data transmission to reduce a burden on the network, but also ensure integrity of the first communication data and increase data transmission efficiency, thereby greatly improving communication quality.

In an application scenario of data synchronization of an IoT network, an embodiment of the disclosure further provides a method for data synchronization, and the method may include: receiving first synchronization data sent by a first gateway through the at least one network channel, where the at least one network channel is selected and obtained by the first gateway from a plurality of network channels established based on different network protocols, and the first synchronization data is sent by a first IoT terminal to a shared transmit queue of the first gateway for caching; determining a second IoT terminal associated with the first IoT terminal; and sending the first synchronization data to the second IoT terminal, so that the second IoT terminal performs data synchronization based on the first synchronization data.

In one embodiment, the first gateway, the first IoT terminal, the second gateway, and the second IoT terminal are deployed in the same site area.

After receiving first synchronization data, the second IoT terminal performs data synchronization to store and update the first synchronization data. Using the first IoT terminal as a ticket verification terminal and the first synchronization data as ticket verification information, after receiving the ticket verification information, the second terminal changes the status of the corresponding ticket based on the ticket verification information, so that when a user verifies the ticket on the second terminal, a prompt that the ticket has been verified will be given, to avoid the vulnerability of fare evasion caused by verifying one ticket a plurality of times.

The specific implementation of this embodiment of the disclosure has been described in detail above and will not be described herein again.

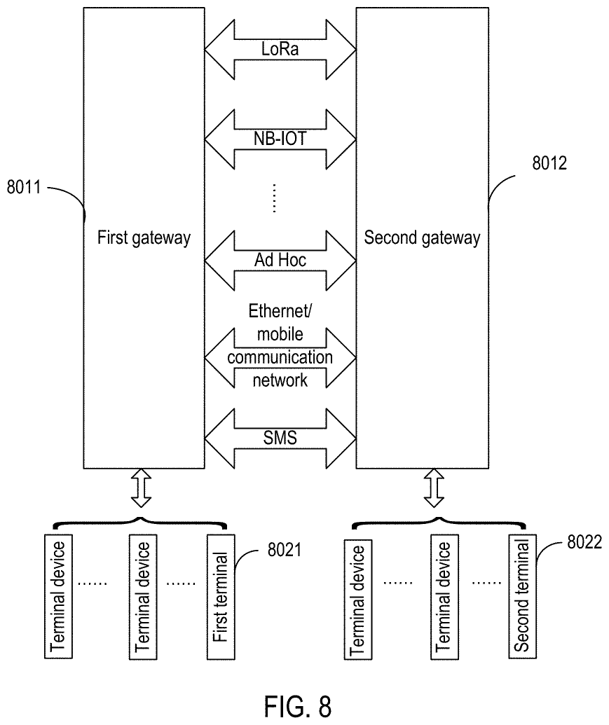

FIG. 8 is a block diagram illustrating a system for data communication provided in embodiments of the disclosure.

The system for communication may include a plurality of gateways (801) deployed in the same site and at least one terminal (802) connected to each gateway, where any two gateways establish a plurality of network channels therebetween based on different network protocols.

A first gateway (8011) is configured to cache first communication data sent by a first terminal (8021) in a shared transmit queue; select at least one network channel from a plurality of network channels established based on different network protocols; and send the first communication data in the shared transmit queue to a second gateway (8012) through the at least one network channel.

The second gateway (8012) is configured to receive, through the at least one network channel, the first communication data sent by the first gateway (8011), and send the first communication data to a second terminal (8022).

The system for data communication provided in this embodiment of the disclosure can avoid the phenomenon that use of only one network channel for data communication affects data communication between devices and thus affects actual service processing due to paralysis or congestion of the network channel. It provides a base for using at least one network channel to jointly perform data communication between devices, to achieve higher communication efficiency and communication quality.

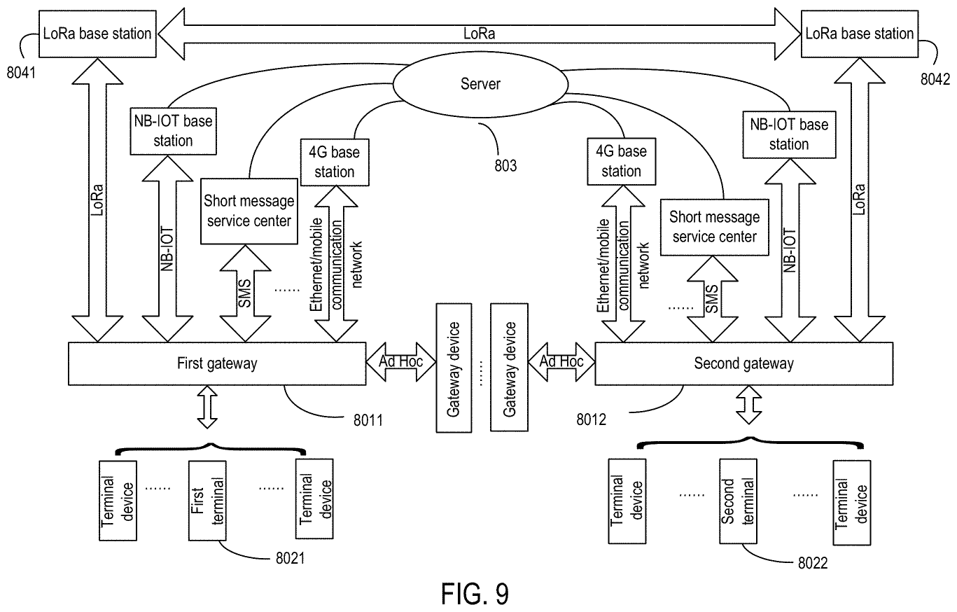

FIG. 9 is a block diagram illustrating a system for data communication provided in embodiments of the disclosure.

In addition to the first gateway (8011), the second gateway (8012), the first terminal (8021), and the second terminal (8022) in the embodiment of FIG. 8, the system may further include a server (803) and a self-organizing network base station (8041, 8042) in this embodiment of the disclosure.

The plurality of gateways respectively establish network connections to the server based on different network protocols, where a network channel corresponding to any network protocol between any two gateways is formed by the two gateways by respectively establishing network connections to the server (803) based on the network protocol.

The first gateway (8011) sending the first communication data in the shared transmit queue to a second gateway (8012) through the at least one network channel is specifically sending the first communication data in the shared transmit queue to the server through the at least one network channel.

The server (803) is configured to receive the first communication data sent by the first gateway (8011) through the at least one network channel; determine a second gateway (8012) associated with the first gateway (8011); and forward the first communication data to the second gateway (8012) through the at least one network channel.

The second gateway (8012) is configured to determine a second terminal (8022) associated with the first terminal (8021); and send the first communication data to the second terminal (8022).

The specific implementation of the gateway device establishing a network connection to the server based on different network protocols to form different network channels in this embodiment of the disclosure has been described in detail above and will not be described herein again.

The plurality of gateway devices (8011, 8012) respectively establish network connections to respective corresponding self-organizing network base stations (8041, 8042) based on at least one self-organizing network protocol, where a self-organizing network channel corresponding to any self-organizing network protocol between any two gateways is formed by the two gateways by respectively establishing network connections to corresponding self-organizing network base stations (8041, 8042) based on the self-organizing network protocol. The self-organizing network base station may be a LoRa base station, which is not specifically limited herein.

If the at least one network channel is the at least one self-organizing network channel, then the first gateway (8011) sending the first communication data in the shared transmit queue to a second gateway (8012) through the at least one network channel may be specifically sending the first communication data in the shared transmit queue to respective corresponding self-organizing network base stations (8041, 8042) through the at least one self-organizing network channel.

The self-organizing network base station (8041, 8042) is configured to determine the second gateway (8012) associated with the first gateway (8011); and send the first communication data to the second gateway (8012) through the corresponding self-organizing network channel.

Using a LoRa network channel as an example, if the first gateway and the second gateway are respectively connected to a first LoRa base station (8041) and a second LoRa base station (8042), then the self-organizing network base station (8041, 8042) being configured to determine the second gateway (8012) associated with the first gateway (8011); and send the first communication data to the second gateway (8012) through the corresponding self-organizing network channel is specifically: the first LoRa base station (8041) determines the second LoRa base station (8042) connected to the second gateway and sends the first communication data to the second LoRa base station (8042); the second LoRa base station (8042) determines the second gateway (8012) associated with the first gateway (8011) and sends the first communication data to the second gateway (8012) through the LoRa network channel.

The self-organizing network base stations (8041, 8042) in this system may further respectively establish network connections to the server (803) to form self-organizing network channels between the first gateway (8011) and the second gateway (8022). The implementation example of the disclosure has been described in detail above and will not be described herein again.

Optionally, the system may further include NB-IoT base stations, where the NB-IoT network channel is formed by the first gateway by establishing a network connection to a first NB-IoT base station based on an NB-IoT protocol, by the second gateway by establishing a network connection to a second NB-IoT base station based on the NB-IoT protocol, and by the first NB-IoT base station and the second NB-IoT base station by respectively establishing network connections to the server.

The server receiving the first communication data sent by the first gateway (8011) through the at least one network channel is specifically: receiving the first communication data sent by the first gateway through the first NB-IoT base station.

The server forwarding the first communication data to the second gateway through the at least one network channel is specifically: forwarding the first communication data to the second gateway through the second NB-IoT base station.

The system may further include a SMS center for an SMS network, and may further include a mobile communication base station for a mobile communication network, which has been described in detail above and will not be described herein again.

Since the ad hoc network is a multi-hop network structure without a central organization, an ad hoc network channel between the first gateway and the second gateway may be formed by using network connections established between a plurality of gateway devices based on the ad hoc network protocol. The topology structure of the ad hoc network may be specifically built according to actual requirements, which is not specifically limited herein.

The specific implementation of this embodiment of the disclosure has been described in detail above and will not be described herein again.

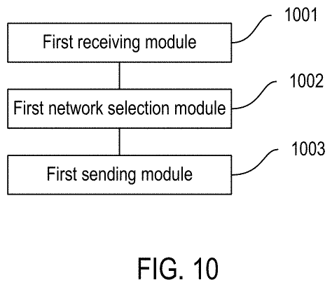

FIG. 10 is a block diagram illustrating an apparatus for data communication provided in embodiments of the disclosure.

The apparatus may be implemented by a gateway device and may include: a first receiving module (1001), configured to cache, by a first gateway, first communication data sent by a first terminal in a shared transmit queue; a first network selection module (1002), configured to select at least one network channel from a plurality of network channels established based on different network protocols; and a first sending module (1003), configured to send the first communication data in the shared transmit queue to a second gateway through the at least one network channel, so that the second gateway sends the first communication data to a second terminal.

In one embodiment, the first gateway, the first terminal, the second gateway, and the second terminal are deployed in the same site area.

The first receiving module (1001) may be specifically configured to: receive, by the first gateway, the first communication data sent by the first terminal; and cache the first communication data in the shared transmit queue.

In some embodiments, before the first network selection module (1002), the apparatus may further include: a first judgment module, configured to determine whether the second terminal is interconnected to the first gateway, and if so, then trigger an intranet sending module; if not, then trigger the first network selection module (1002); and the intranet sending module, configured to send the first communication data to the second terminal.

The specific implementation of this embodiment of the disclosure has been described in detail above and will not be described herein again.

In this embodiment of the disclosure, the phenomenon that use of only one network channel for data communication affects data communication between devices and thus affects actual service processing due to paralysis or congestion of the network channel can be avoided. At least one network channel is selected to jointly perform data communication between devices, to achieve higher communication efficiency and communication quality. In addition, the combination of different network channels can meet communication requirements in a variety of service scenarios and can desirably counteract the impact of an external environment on device communication, thereby achieving stable and reliable data transmission of communication between devices.

In one embodiment, the first gateway, no matter whether connected to a non-self-organizing network or connected to a self-organizing network, can establish at least one network connection to the server through a self-organizing network protocol or a non-self-organizing network protocol, and the second gateway establishes at least one network connection to the server in the aforementioned manner, to form a plurality of network channels between the first gateway and the second gateway built based on different network protocols. The first sending module (1003) may be specifically configured to: send the first communication data in the shared transmit queue to the server through the at least one network channel, so that the server sends the first communication data to the second gateway through the at least one network channel.

In some embodiments, the plurality of network protocols may include a NB-IoT communication protocol; and the sending the first communication data in the shared transmit queue to the server through the at least one network channel, so that the server sends the first communication data to the second gateway through the at least one network channel may be specifically configured to: if the at least one network channel includes an NB-IoT network channel, then send the first communication data in the shared transmit queue to the server through a first NB-IoT base station, so that the server sends the first communication data to the second gateway through the second NB-IoT base station.

In one embodiment, the first sending module (1003) may be specifically configured to: if the at least one network channel is self-organizing network channels established based on different network protocols, then separately send the first communication data in the shared transmit queue to corresponding self-organizing network base stations based on the at least one self-organizing network channel, so that the self-organizing network base stations respectively send the first communication data to the second gateway through respective corresponding self-organizing network channels.

As one embodiment, the first sending module (1003) may be specifically configured to: if the at least one network channel includes at least one self-organizing network channel established based on different network protocols and at least one non-self-organizing network channel established based on different network protocols, then respectively send the first communication data in the shared transmit queue to corresponding self-organizing network base stations through the at least one self-organizing network channel, so that the self-organizing network base stations respectively forward the first communication data to the second gateway through the at least one self-organizing network channel; and respectively send the first communication data in the shared transmit queue to the server through the at least one non-self-organizing network channel, so that the server forwards the first communication data to the second gateway through the at least one non-self-organizing network channel.

In this embodiment of the disclosure, a plurality of approaches of building different network channels are provided, and an appropriate approach of building network channels may be specifically selected according to actual service requirements and application scenarios to implement data communication between the first gateway and the second gateway.

Based on the above, different networks have different network characteristics. Thus, different networks are affected by the external environment to varying levels, for example, flow of people, weather, interference signals in the environment, or data amount of communication data, and each network channel has varying data transmission performance at different time points. Thus, the first network selection module (1002) may be specifically configured to: monitor data transmission performance of the plurality of network channels; and select at least one network channel from the plurality of network channels according to the data transmission performance of the plurality of network channels and a cached data amount in the shared transmit queue.

The specific implementation of this embodiment of the disclosure has been described in detail above and will not be described herein again.

In this embodiment of the disclosure, the method and policy for selecting network channels according to requirements in different application scenarios and service scenarios is exemplarily described. Certainly, to facilitate automatic selection of network channels, different network selection models may further be set based on service requirements, comprehensive consideration and selection are made in a plurality of dimensions such as the data transmission performance of each network channel, transmission requirements of communication data, and service requirements, and a weight of each dimension is set to obtain an optimal network channel combination, which is not specifically limited herein.

In one embodiment, the first caching module may be specifically configured to: code the first communication data according to a preset coding protocol to obtain at least one data packet; and cache the at least one data packet in the shared transmit queue.

The first sending module (1003) may be specifically configured to: determine data packet proportions of the at least one network channel; and send the data packets in the shared transmit queue to the second gateway through the at least one network channel according to respective data packet proportions.

Therefore, optionally, the apparatus for data communication may further include: a first network channel monitoring module, configured to monitor data transmission performance of the at least one network channel during sending of the data packets; and a proportion adjustment module, configured to adjust the data packet proportions of the at least one network channel if the data transmission performance changes.

The sending the data packets in the shared transmit queue to the second gateway through the at least one network channel according to respective data packet proportions may be specifically configured to: continue to send the data packets in the shared transmit queue to the second gateway through the at least one network channel according to respective adjusted data packet proportions.

In one embodiment, the proportion adjustment module may be specifically configured to: separately determine whether the data transmission performance of the at least one network channel is greater than a preset threshold; if data transmission performance of any network channel is greater than or equal to the preset threshold, then determine whether a transmitted data amount of the network channel is less than a first transmission threshold; if the transmitted data amount is less than the first transmission threshold, then increase a data packet proportion of the network channel; if the data transmission performance of the network channel is less than the preset threshold, then determine whether the transmitted data amount of the network channel is greater than a second transmission threshold; and if the transmitted data amount is greater than the second transmission threshold, then decrease the data packet proportion of the network channel.

In one embodiment, the apparatus for data communication may further include: a second network channel monitoring module, configured to monitor data transmission performance of the at least one network channel during sending of the data packets; a transmission capacity determining module configured to, if the data transmission performance changes, determine whether a current data transmission capacity of the at least one network channel is less than a data amount of the data packets in the shared transmit queue; and if so, trigger a network channel adjustment module; the network channel adjustment module, configured to reselect at least one network channel from the plurality of network channels and determine data packet proportions of the at least one reselected network channel.

The sending the data packets in the shared transmit queue to the second gateway through the at least one network channel according to respective data packet proportions may be specifically configured to: send the data packets in the shared transmit queue to the second gateway through the at least one reselected network channel according to the respective data packet proportions.

Since the network channel has a limited data capacity, unnecessary data transmission may be reduced as much as possible. Thus, the first caching module may be specifically configured to: set a sequence number for each data packet in an ascending manner according to a coding order of the at least one data packet; and sequentially cache the at least one data packet in the shared transmit queue in an ascending order of the sequence numbers.

In some embodiments, the sending the data packets in the shared transmit queue to the second gateway through the at least one network channel according to respective data packet proportions may be specifically configured to: determine sequence numbers of data packets respectively corresponding to the at least one network channel according to the respective corresponding data proportions; sequentially acquire the data packets in the shared transmit queue; and separately send the data packets in the shared transmit queue to the second gateway through the at least one network channel according to the respective corresponding sequence numbers.

After the separately sending the data packets in the shared transmit queue to the second gateway through the at least one network channel according to the respective corresponding sequence numbers, the apparatus may further include: a retransmission request receiving module, configured to receive a retransmission request sent by the second gateway, where the retransmission request carries a sequence number of an unreceived data packet; a caching module, configured to cache a data packet corresponding to the sequence number of the unreceived data packet in a shared retransmission queue; and a shared retransmission queue sending module, configured to send the data packet in the shared retransmission queue to the second gateway through the at least one network channel.

The specific implementation of this embodiment of the disclosure has been described in detail above and will not be described herein again.

In this embodiment of the disclosure, the data transmission performance of each network channel is monitored in real time, so that the data packet proportion of each network channel can be adjusted according to the change of the data transmission performance of each network channel to achieve better communication quality. In addition, at least one network channel may further be reselected according to actual requirements to meet data communication requirements, to ensure that the at least one network channel has the optimum data transmission capability and meets actual service requirements and communication requirements.

In an application scenario of data synchronization of an IoT network, an embodiment of the disclosure further provides an apparatus for data synchronization, and the apparatus may include: a first receiving module, configured to cache, by a first gateway, first synchronization data sent by a first IoT terminal in a shared transmit queue; a first network selection module, configured to select at least one network channel from a plurality of network channels established based on different network protocols; and a first sending module, configured to send the first synchronization data in the shared transmit queue to a second gateway through the at least one network channel, so that the second gateway sends the first synchronization data to a second IoT terminal and the second IoT terminal performs data synchronization according to the first synchronization data.

In one embodiment, the first gateway, the first IoT terminal, the second gateway, and the second IoT terminal are deployed in the same site area.

The specific implementation of this embodiment of the disclosure has been described in detail above and will not be described herein again.

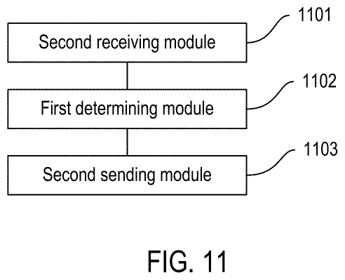

FIG. 11 is a block diagram illustrating an apparatus for data communication provided in embodiments of the disclosure.

The apparatus may be implemented by a server and may include: a second receiving module (1101), configured to receive first communication data sent by a first gateway through at least one network channel, where the at least one network channel is selected and obtained by the first gateway from a plurality of network channels established based on different network protocols, and the first communication data is sent by a first terminal to a shared transmit queue of the first gateway for caching; a first determining module (1102), configured to determine a second gateway associated with the first gateway; and a second sending module (1103), configured to forward the first communication data to the second gateway through the at least one network channel, so that the second gateway sends the first communication data to a second terminal.

In one embodiment, the first gateway, the first terminal, the second gateway, and the second terminal are deployed in the same site area.

The plurality of network protocols may include a NB-IoT communication protocol. As one embodiment, if the at least one network channel includes an NB-IoT network channel, then the second receiving module (1101) may be specifically configured to: receive the first communication data sent by the first gateway through a first NB-IoT base station in the NB-IoT network channel.

The second sending module (1103) may be specifically configured to: forward the first communication data to the second gateway through a second NB-IoT base station in the NB-IoT network channel, so that the second gateway sends the first communication data to the second terminal.

Further, the forwarding the first communication data to the second gateway through the second NB-IoT base station, so that the second gateway sends the first communication data to the second terminal may be specifically configured to: group second gateways connected to the second NB-IoT base station according to a downlink communication capability of the second NB-IoT base station; and control the second NB-IoT base station to sequentially forward the first communication data to each corresponding group of second gateways according to the grouping, so that the second gateways send the first communication data to the second terminal.

In this embodiment of the disclosure, the server stores an association relationship between devices, and after receiving first communication data, the server determines a second gateway connected to a second terminal and a network base station or SMS center connected to the second gateway based on the pre-stored association relationship between devices, to achieve control over delivery of the first communication data. The control over sending of the communication data by the server can increase the data communication efficiency and enhance the security and reliability of data communication, thereby further improving the quality of communication between devices.

The specific implementation of this embodiment of the disclosure has been described in detail above and will not be described herein again.

In an application scenario of data synchronization of an IoT network, an embodiment of the disclosure further provides an apparatus for data synchronization, and the apparatus may include: a second receiving module, configured to receive, by a first synchronization data receiving module, first synchronization data sent by a first gateway through at least one network channel, where the at least one network channel is selected and obtained by the first gateway from a plurality of network channels established based on different network protocols, and the first synchronization data is sent by a first IoT terminal to the first gateway; a first determining module, configured to determine a second gateway associated with the first gateway; and a second sending module, configured to forward the first synchronization data to the second gateway through the at least one network channel, so that the second gateway sends the first synchronization data to a second IoT terminal and the second IoT terminal performs data synchronization based on the first synchronization data.

In one embodiment, the first gateway, the first IoT terminal, the second gateway, and the second IoT terminal are deployed in the same site area.

The specific implementation of this embodiment of the disclosure has been described in detail above and will not be described herein again.

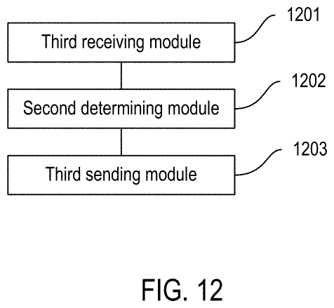

FIG. 12 is a block diagram illustrating an apparatus for data communication provided in embodiments of the disclosure.

The apparatus may be implemented by a base station device and may include: a third receiving module (1201), configured to receive first communication data sent by a first gateway through a self-organizing network channel, where the self-organizing network channel is selected and obtained by the first gateway from a plurality of network channels established based on different network protocols, and the first communication data is sent by a first terminal to a shared transmit queue of the first gateway for caching; a second determining module (1202), configured to determine a second gateway associated with the first gateway; and a third sending module (1203), configured to forward the first communication data to the second gateway through the self-organizing network channel, so that the second gateway sends the first communication data to a second terminal.

In one embodiment, the first gateway, the first terminal, the second gateway, and the second terminal are deployed in the same site area.

The specific implementation of this embodiment of the disclosure has been described in detail above and will not be described herein again.

In this embodiment of the disclosure, the self-organizing network base station pre-stores an association relationship between devices, and determines a second gateway connected to a second terminal and a self-organizing network base station connected to the second gateway based on the association relationship between devices, to achieve control over delivery of first communication data. The control over sending of the first communication data by the self-organizing network base station can not only reduce network use costs of a user, but also increase the data communication efficiency and enhance the security and reliability of data communication, thereby further improving the quality of communication between devices.

In an application scenario of data synchronization of an IoT network, an embodiment of the disclosure further provides an apparatus for data synchronization, and the apparatus may include: a third receiving module, configured to receive first synchronization data sent by a first gateway through a self-organizing network channel, where the self-organizing network channel is selected and obtained by the first gateway from a plurality of network channels established based on different network protocols, and the first synchronization data is sent by a first IoT terminal to a shared transmit queue of the first gateway for caching; a second determining module, configured to determine a second gateway associated with the first gateway; and a third sending module, configured to forward the first synchronization data to the second gateway through the self-organizing network channel so that the second gateway sends the first communication data to a second IoT terminal and the second IoT terminal performs data synchronization based on the first synchronization data.

In one embodiment, the first gateway, the first IoT terminal, the second gateway, and the second IoT terminal are deployed in the same site area.

The specific implementation of this embodiment of the disclosure has been described in detail above and will not be described herein again.

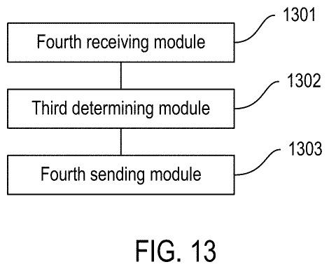

FIG. 13 is a block diagram illustrating an apparatus for data communication provided in embodiments of the disclosure.

The apparatus may be implemented by a gateway device and may include: a fourth receiving module (1301), configured to receive first communication data sent by a first gateway through the at least one network channel, where the at least one network channel is selected and obtained by the first gateway from a plurality of network channels established based on different network protocols, and the first communication data is sent by a first terminal to a shared transmit queue of the first gateway for caching; a third determining module (1302), configured to determine a second terminal associated with the first terminal; and a fourth sending module (1303), configured to send the first communication data to the second terminal.

In one embodiment, the first gateway, the first terminal, the second gateway, and the second terminal are deployed in the same site area.

Besides, it is possible that a device association relationship pre-stored in a local gateway device is not updated in time or a record is erroneous. In this case, the second terminal may not be connected to the second gateway, causing communication interruption. Therefore, after receiving first communication data sent by a first gateway through the at least one network channel, the apparatus may further include: a fourth determining module, configured to determine whether the second terminal is connected to the second gateway; a prompt information generation module, configured to generate error prompt information if the second terminal is not connected to the second gateway; and a prompt information output module, configured to output, by the second gateway, the error prompt information or send the error prompt information to the first gateway.

Thus, as an optional implementation, the fourth receiving module (1301) may be specifically configured to: separately receive at least one data packet sent by the at least one network channel selected by the first gateway, where the at least one data packet is obtained by the first gateway by coding the first communication data based on a preset coding protocol; deduplicate the at least one data packet based on a sequence number of each data packet, and sequentially cache data packets obtained after deduplication in a shared receive queue in an ascending order of sequence numbers; and sequentially decode the data packets in the shared receive queue according to a preset decoding protocol to obtain the first communication data.

In practice, packet loss still occurs in the process of data transmission. After the deduplicating the at least one data packet based on a sequence number of each data packet, and sequentially caching data packets obtained after deduplication in a shared receive queue in an ascending order of sequence numbers, the apparatus may further include: a sequence number detection module, configured to detect a sequence number of an unreceived data packet; a retransmission request generation module, configured to generate a retransmission request based on the sequence number of the unreceived data packet and send the retransmission request to the first gateway; and a fifth receiving module, configured to receive a second data packet resent by the first gateway in response to the retransmission request.

Depending on different approaches of building different network channels, the first communication data sent by the at least one network channel and received by the second gateway device may be transmitted based on a network channel formed by a network connection between a server and the second gateway. In one embodiment, the fourth receiving module (1301) may be specifically configured to: receive the first communication data forwarded by the first gateway through the at least one network channel via a server.

In the case in which a self-organizing network is not connected to the server, the second gateway receiving first communication data sent by a self-organizing network channel may be transmission based on a network channel formed by a network connection between a self-organizing network base station and the second gateway. In one embodiment, the fourth receiving module (1301) may be specifically configured to: receive the first communication data forwarded by the first gateway through the self-organizing network channel via the self-organizing network base station.

In one embodiment, the self-organizing network channel is selected and obtained by the first gateway from a plurality of network channels established based on different network protocols.

The specific implementation of this embodiment of the disclosure has been described in detail above and will not be described herein again.

In this embodiment of the disclosure, the processing of the gateway device after receiving the first communication data is described in detail, and the at least one data packet sent by the first gateway through the at least one network channel is deduplicated and decoded to obtain the first communication data. Unlike current systems in which the second gateway needs to send to the first gateway an acknowledgment frame data packet for each received data packet, in this embodiment of the disclosure, a lost data packet is determined according to sequence numbers of data packets, and only a retransmission request is sent to the first gateway so that the first gateway retransmits the lost data packet, which can not only effectively reduce unnecessary data transmission to reduce a burden on the network, but also ensure integrity of the first communication data and increase data transmission efficiency, thereby greatly improving communication quality.

In an application scenario of data synchronization of an IoT network, an embodiment of the disclosure further provides an apparatus for data synchronization, and the apparatus may include: a fourth receiving module, configured to receive first synchronization data sent by a first gateway through the at least one network channel, where the at least one network channel is selected and obtained by the first gateway from a plurality of network channels established based on different network protocols, and the first synchronization data is sent by a first IoT terminal to a shared transmit queue of the first gateway for caching; a third determining module, configured to determine a second IoT terminal associated with the first IoT terminal; and a fourth sending module, configured to send the first synchronization data to the second IoT terminal, so that the second IoT terminal performs data synchronization based on the first synchronization data.

In one embodiment, the first gateway, the first IoT terminal, the second gateway, and the second IoT terminal are deployed in the same site area.

The specific implementation of this embodiment of the disclosure has been described in detail above and will not be described herein again.

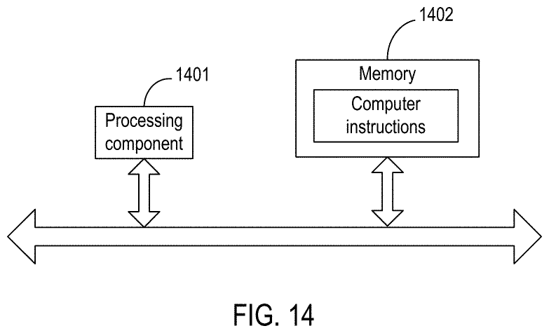

FIG. 14 is a block diagram illustrating a gateway device provided in embodiments of the disclosure. The gateway device may include a processing component (1401) and a storage component (1402).

The storage component (1402) is configured to store one or a plurality of computer instructions, where the one or plurality of computer instructions are invoked and executed by the processing component (1401).

The processing component (1401) may be configured to: cache, by a first gateway, first communication data sent by a first terminal in a shared transmit queue; select at least one network channel from a plurality of network channels established based on different network protocols; and send the first communication data in the shared transmit queue to a second gateway through the at least one network channel, so that the second gateway sends the first communication data to a second terminal, where the first gateway, the first terminal, the second gateway, and the second terminal are deployed in the same site area.

The processing component (1401) may include one or a plurality of processors to execute computer instructions to perform all or some of the steps in the method described above. The processing component may also be implemented by one or a plurality of application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic elements, to perform the method described above.

The storage component (1402) is configured to store various types of data to support the operation in a server. The storage component may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

In one embodiment, the gateway device may definitely further include other parts, for example, an input/output interface or a communication component.

The input/output interface provides an interface between the processing component and a peripheral interface module, where the peripheral interface module may be an output device, an input device, or the like.

The communication component is configured to facilitate communication between the server and other devices in a wired or wireless manner, for example, communication with a terminal.

An embodiment of the disclosure further provides a computer-readable storage medium having a computer program stored therein, where when executed by a computer, the computer program can implement the method for data communication in the embodiment shown in FIG. 1.

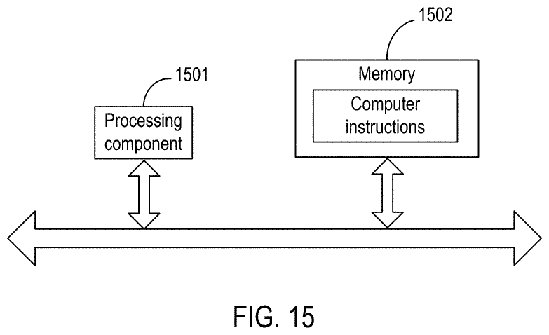

FIG. 15 is a block diagram illustrating a server provided in embodiments of the disclosure. The server may include a processing component (1501) and a storage component (1502).

The storage component (1502) is configured to store one or a plurality of computer instructions, where the one or plurality of computer instructions are invoked and executed by the processing component (1501).

The processing component (1501) may be configured to: receive first communication data sent by a first gateway through at least one network channel, where the at least one network channel is selected and obtained by the first gateway from a plurality of network channels established based on different network protocols, and the first communication data is sent by a first terminal to a shared transmit queue of the first gateway for caching; determine a second gateway associated with the first gateway; and forward the first communication data to the second gateway through the at least one network channel, so that the second gateway sends the first communication data to a second terminal, where the first gateway, the first terminal, the second gateway, and the second terminal are deployed in the same site area.

The processing component (1501) may include one or a plurality of processors to execute computer instructions to perform all or some of the steps in the method described above. The processing component may also be implemented by one or a plurality of application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic elements, to perform the method described above.

The storage component (1502) is configured to store various types of data to support the operation in the server. The storage component may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The server may definitely further include other parts, for example, an input/output interface or a communication component. The input/output interface provides an interface between the processing component and a peripheral interface module, where the peripheral interface module may be an output device, an input device, or the like. The communication component is configured to facilitate communication between the server and other devices in a wired or wireless manner, for example, communication with a terminal.

An embodiment of the disclosure further provides a computer-readable storage medium having a computer program stored therein, where when executed by a computer, the computer program can implement the method for data communication in the embodiment shown in FIG. 5.

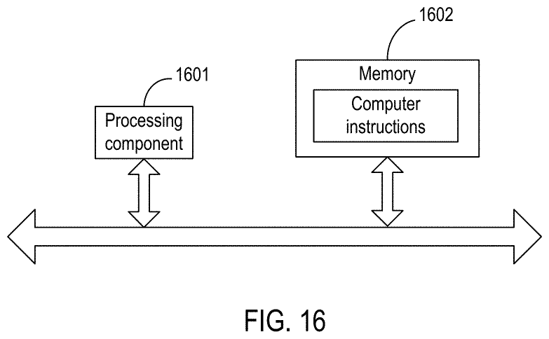

FIG. 16 is a block diagram illustrating a base station device provided in embodiments of the disclosure. The server may include a processing component (1601) and a storage component (1602).

The storage component (1602) is configured to store one or a plurality of computer instructions, where the one or plurality of computer instructions are invoked and executed by the processing component (1501).

The processing component (1601) may be configured to: receive first communication data sent by a first gateway through a corresponding self-organizing network channel, where the self-organizing network channel is selected and obtained by the first gateway from a plurality of network channels established based on different network protocols, and the first communication data is sent by a first terminal to a shared transmit queue of the first gateway for caching; determine a second gateway associated with the first gateway; and forward the first communication data to the second gateway through the self-organizing network channel, so that the second gateway sends the first communication data to a second terminal, where the first gateway, the first terminal, the second gateway, and the second terminal are deployed in the same site area.

The processing component (1601) may include one or a plurality of processors to execute computer instructions to perform all or some of the steps in the method described above. The processing component may also be implemented by one or a plurality of application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic elements, to perform the method described above.

The storage component (1602) is configured to store various types of data to support the operation in a server. The storage component may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The base station device may definitely further include other parts, for example, an input/output interface or a communication component. The input/output interface provides an interface between the processing component and a peripheral interface module, where the peripheral interface module may be an output device, an input device, or the like. The communication component is configured to facilitate communication between the server and other devices in a wired or wireless manner, for example, communication with a terminal.

An embodiment of the disclosure further provides a computer-readable storage medium having a computer program stored therein, where when executed by a computer, the computer program can implement the method for data communication in the embodiment shown in FIG. 6.

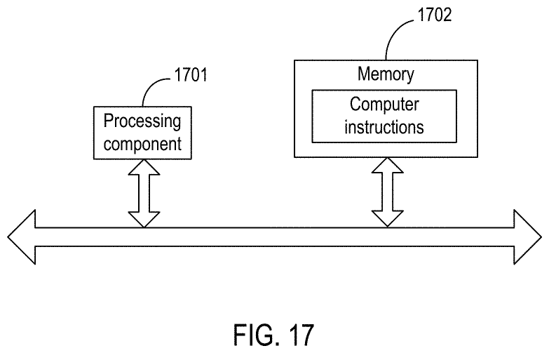

FIG. 17 is a block diagram illustrating a gateway device provided in embodiments of the disclosure. The gateway device may include a processing component (1701) and a storage component (1702).

The storage component (1702) is configured to store one or a plurality of computer instructions, where the one or plurality of computer instructions are invoked and executed by the processing component (1701).

The processing component (1701) may be configured to: receive first communication data sent by a first gateway through the at least one network channel, where the at least one network channel is selected and obtained by the first gateway from a plurality of network channels established based on different network protocols, and the first communication data is sent by a first terminal to a shared transmit queue of the first gateway for caching; determine a second terminal associated with the first terminal; and send the first communication data to the second terminal, where the first gateway, the first terminal, the second gateway, and the second terminal are deployed in the same site area.

The processing component (1701) may include one or a plurality of processors to execute computer instructions to perform all or some of the steps in the method described above. The processing component may also be implemented by one or a plurality of application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic elements, to perform the method described above.

The storage component (1702) is configured to store various types of data to support the operation in a server. The storage component may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The gateway device may definitely further include other parts, for example, an input/output interface or a communication component.

The input/output interface provides an interface between the processing component and a peripheral interface module, where the peripheral interface module may be an output device, an input device, or the like.

The communication component is configured to facilitate communication between the server and other devices in a wired or wireless manner, for example, communication with a terminal.

An embodiment of the disclosure further provides a computer-readable storage medium having a computer program stored therein, where when executed by a computer, the computer program can implement the method for data communication in the embodiment shown in FIG. 7.

Those skilled in the art can clearly understand that for convenience and simplicity of description, for the specific working process of the system, apparatus, and units described above, reference may be made to the corresponding process in the foregoing method embodiments, which will not be described herein again.

The apparatus embodiment described above is merely exemplary. The units described as separate parts may or may not be physically separated; and the components shown as units may or may not be physical units. That is, the components may be located in one place or may be distributed onto a plurality of network units. The objective of the solution of this embodiment may be achieved by selecting some or all of the modules according to actual requirements. Those of ordinary skill in the art can understand and implement the present invention without significant efforts.

Through the preceding description of the embodiments, those skilled in the art can clearly understand that the embodiments can be implemented by software plus a necessary general hardware platform, and certainly can also be implemented by hardware. Based on such understanding, the technical solutions essentially, or the part contributing to current systems may be implemented in the form of a software product. The computer software product may be stored in a computer-readable storage medium such as a ROM/RAM, a magnetic disk, or an optical disk, and includes a plurality of instructions for instructing a computer device (which may be a personal computer, a server, or a network device) to perform the methods described in the embodiments or some part of the embodiments.

Finally, it should be noted that the above embodiments are merely provided for describing the technical solutions of the disclosure, but not intended to limit the disclosure. It should be understood by those of ordinary skill in the art that although the disclosure has been described in detail with reference to the foregoing embodiments, modifications can be made to the technical solutions described in the foregoing embodiments, or equivalent replacements can be made to some technical features in the technical solutions, as long as such modifications or replacements do not cause the essence of corresponding technical solutions to depart from the spirit and scope of the technical solutions in the embodiments of the disclosure.

What is claimed is:

1. A method comprising:
caching, by a first gateway, first communication data sent by a first terminal in a shared transmit queue;
selecting, by the first gateway, at least one network channel from a plurality of network channels established based on different network protocols; and
sending, by the first gateway, the first communication data in the shared transmit queue to a second gateway through the at least one network channel, the sending causing the second gateway to transmit the first communication data to a second terminal, the first gateway, the first terminal, the second gateway, and the second terminal deployed in a same site area.

2. The method of claim 1, the selecting at least one network channel comprising selecting the at least one network channel based on monitored data transmission performances of the plurality of network channels and a cached data amount in the shared transmit queue.

3. The method of claim 1, the caching the first communication data comprising:
coding the first communication data using a preset coding protocol to obtain at least one data packet;
caching the at least one data packet in the shared transmit queue; and
the sending the first communication data in the shared transmit queue to a second gateway through the at least one network channel comprising:
determining data packet proportions of the at least one network channel; and
sending the data packets in the shared transmit queue to the second gateway through the at least one network channel according to respective data packet proportions.

4. The method of claim 3, further comprising:
monitoring data transmission performance of the at least one network channel during sending of the data packets; and
adjusting the data packet proportions of the at least one network channel when the data transmission performance changes; and
continuing to send the data packets in the shared transmit queue to the second gateway through the at least one network channel according to respective adjusted data packet proportions.

5. The method of claim 4, the adjusting the data packet proportions of the at least one network channel comprising:
determining whether the data transmission performance of the at least one network channel is greater than a preset threshold;
determining if a transmitted data amount of the network channel is less than a first transmission threshold when data transmission performance of any network channel is greater than or equal to the preset threshold;
increasing a data packet proportion of the network channel if the transmitted data amount is less than the first transmission threshold;
determining if the transmitted data amount of the network channel is greater than a second transmission threshold if the data transmission performance of the network channel is less than the preset threshold; and
decreasing the data packet proportion of the network channel if the transmitted data amount is greater than the second transmission threshold.

6. The method of claim 3, further comprising:
monitoring data transmission performance of the at least one network channel during sending of the data packets;
determining if a current data transmission capacity of the at least one network channel is less than a data amount of the data packets in the shared transmit queue if the data transmission performance changes; and
if the current data transmission capacity of the at least one network channel is less than a data amount of the data packets in the shared transmit queue, reselecting at least one network channel from the plurality of network channels and determining data packet proportions of the at least one reselected network channel; and
sending the data packets in the shared transmit queue to the second gateway through the at least one reselected network channel according to the respective data packet proportions.

7. The method of claim 3, the caching the at least one data packet comprising:
setting a sequence number for each data packet in an ascending order based on a coding order of the at least one data packet; and
sequentially caching the at least one data packet in the shared transmit queue in an ascending order of the sequence numbers.

8. The method of claim 7, the sending the data packets in the shared transmit queue to the second gateway through the at least one network channel according to respective data packet proportions comprises:
determining sequence numbers of data packets respectively corresponding to the at least one network channel according to the respective corresponding data packet proportions;
sequentially acquiring the data packets in the shared transmit queue; and
separately sending the data packets in the shared transmit queue to the second gateway through the at least one network channel based on the respective corresponding sequence numbers.

9. The method of claim 8, wherein after the separately sending the data packets in the shared transmit queue to the second gateway through the at least one network channel based on the respective corresponding sequence numbers, the method further comprises:
receiving a retransmission request sent by the second gateway, wherein the retransmission request carries a sequence number of an unreceived data packet;
caching a data packet corresponding to the sequence number of the unreceived data packet in a shared retransmission queue; and
sending the data packet in the shared retransmission queue to the second gateway through the at least one network channel.

10. The method of claim 1, the sending the first communication data in the shared transmit queue to a second gateway through the at least one network channel comprises sending the first communication data in the shared transmit queue to the server through the at least one network channel, the sending causing the server to send the first communication data to the second gateway through the at least one network channel.

11. The method of claim 11, the plurality of network protocols including a Narrow Band Internet of Things (NB-IOT) communication protocol, and the sending the first communication data in the shared transmit queue to the server through the at least one network channel, the sending causing the server to send the first communication data to the second gateway through the at least one network channel comprising sending the first communication data in the shared transmit queue to the server through a first NB-IOT base station if the at least one network channel comprises an NB-IOT network channel, the sending causing the server to send the first communication data to the second gateway through the second NB-IOT base station.

12. The method of claim 1, the sending the first communication data to a second gateway through the at least one network channel comprising:
if the at least one network channel is self-organizing network channels established based on different network protocols, separately sending the first communication data in the shared transmit queue to corresponding self-organizing network base stations based on the at least one self-organizing network channel, the sending causing the self-organizing network base stations to respectively send the first communication data to the second gateway through respective corresponding self-organizing network channels.

13. The method of claim 1, the sending the first communication data to a second gateway through the at least one network channel comprising:
if the at least one network channel comprises at least one self-organizing network channel established based on different network protocols and at least one non-self-organizing network channel established based on different network protocols,
respectively sending the first communication data in the shared transmit queue to corresponding self-organizing network base stations through the at least one self-organizing network channel, the sending causing the self-organizing network base stations to respectively forward the first communication data to the second gateway through the at least one self-organizing network channel; and
respectively sending the first communication data in the shared transmit queue to the server through the at least one non-self-organizing network channel, the sending causing the server to forward the first communication data to the second gateway through the at least one non-self-organizing network channel.

14. The method of claim 1, wherein prior to the selecting at least one network channel from a plurality of network channels established based on different network protocols, the method further comprises:
determining whether the second terminal is interconnected to the first gateway;
upon determining that the second terminal is interconnected to the first gate, sending the first communication data to the second terminal; and
selecting at least one network channel from the plurality of network channels established based on different network protocols upon determining that the second terminal is not interconnected to the first gate.

15. A non-transitory computer readable storage medium for tangibly storing computer program instructions capable of being executed by a computer processor, the computer program instructions defining the steps of:
caching, by a first gateway, first communication data sent by a first terminal in a shared transmit queue;
selecting, by the first gateway, at least one network channel from a plurality of network channels established based on different network protocols; and
sending, by the first gateway, the first communication data in the shared transmit queue to a second gateway through the at least one network channel, the sending causing the second gateway to transmit the first communication data to a second terminal, the first gateway, the first terminal, the second gateway, and the second terminal deployed in a same site area.

16. The non-transitory computer readable storage medium of claim 15, the caching the first communication data comprising:
coding the first communication data using a preset coding protocol to obtain at least one data packet;
caching the at least one data packet in the shared transmit queue; and
the sending the first communication data in the shared transmit queue to a second gateway through the at least one network channel comprising:
determining data packet proportions of the at least one network channel; and
sending the data packets in the shared transmit queue to the second gateway through the at least one network channel according to respective data packet proportions.

17. The non-transitory computer readable storage medium of claim 15, the sending the first communication data to a second gateway through the at least one network channel comprising:
if the at least one network channel comprises at least one self-organizing network channel established based on different network protocols and at least one non-self-organizing network channel established based on different network protocols,
respectively sending the first communication data in the shared transmit queue to corresponding self-organizing network base stations through the at least one self-organizing network channel, the sending causing the self-organizing network base stations to respectively forward the first communication data to the second gateway through the at least one self-organizing network channel; and
respectively sending the first communication data in the shared transmit queue to the server through the at least one non-self-organizing network channel, the sending causing the server to forward the first communication data to the second gateway through the at least one non-self-organizing network channel.

18. An apparatus comprising:
a processor; and
a storage medium for tangibly storing thereon program logic for execution by the processor, the stored program logic causing the processor to perform the operations of:
caching, by a first gateway, first communication data sent by a first terminal in a shared transmit queue,
selecting, by the first gateway, at least one network channel from a plurality of network channels established based on different network protocols, and
sending, by the first gateway, the first communication data in the shared transmit queue to a second gateway through the at least one network channel, the sending causing the second gateway to transmit the first communication data to a second terminal, the first gateway, the first terminal, the second gateway, and the second terminal deployed in a same site area.

19. The apparatus of claim 18, the caching the first communication data comprising:
coding the first communication data using a preset coding protocol to obtain at least one data packet;
caching the at least one data packet in the shared transmit queue; and
the sending the first communication data in the shared transmit queue to a second gateway through the at least one network channel comprising:
determining data packet proportions of the at least one network channel; and
sending the data packets in the shared transmit queue to the second gateway through the at least one network channel according to respective data packet proportions.

20. The apparatus of claim 18, the sending the first communication data to a second gateway through the at least one network channel comprising:
if the at least one network channel comprises at least one self-organizing network channel established based on different network protocols and at least one non-self-organizing network channel established based on different network protocols,
respectively sending the first communication data in the shared transmit queue to corresponding self-organizing network base stations through the at least one self-organizing network channel, the sending causing the self-organizing network base stations to respectively forward the first communication data to the second gateway through the at least one self-organizing network channel; and
respectively sending the first communication data in the shared transmit queue to the server through the at least one non-self-organizing network channel, the sending causing the server to forward the first communication data to the second gateway through the at least one non-self-organizing network channel.
